(19) United States
(12) Patent Application Publication
(10) Pub. No.: US 2024/0314405 A1
(43) Pub. Date: Sep. 19, 2024

(54) Purchase Media Metrics for Campaign Planning, Measuring, and Optimization

(71) Applicant: Affinity Solutions, Inc., New York, NY (US)

(72) Inventors: Mike Biamonte, Boonton Township, NJ (US); Michael J. Zenor, Cedar Park, TX (US); Lin Lu, Madison, NJ (US); Atul Chadha, San Jose, CA (US); Saqib Mausoof, Pacifica, CA (US); Daniel Ivan, Astoria, NY (US)

(21) Appl. No.: 18/402,531

(22) Filed: Jan. 2, 2024

Related U.S. Application Data
(60) Provisional application No. 63/478,097, filed on Dec. 30, 2022.

(51) Int. Cl. H04N 21/81; H04N 21/258; H04N 21/442

(52) U.S. Cl. CPC H04N 21/812; H04N 21/25883; H04N 21/44222

(57) ABSTRACT

Purchase Media Metrics (PMM) Platform empowers advertisers to plan their cohort-targeting campaigns in a privacy-safe manner using unique viewer-purchaser graph that connects media views with brand and category purchases. At the same time, the PMM Platform helps publishers/networks identify the best advertisers for their inventories and package and prioritize their media offerings. By further enriching the viewer-purchaser graph with campaign exposure data, the PMM Platform enhances advertisers' campaign measurement and optimization capabilities.

### CROSS-REFERENCE TO RELATED APPLICATIONS

This application claims the benefit of U.S. application No. 63/478,097, filed Dec. 30, 2022. This application is incorporated by reference along with all other references cited in this application.

### BACKGROUND OF THE INVENTION

This invention relates to TV and digital advertising, especially cohort-based media planning and campaign measurement and optimization.

Advertisers want to be assured that their advertising media selections are going to reach actual buyers of what they are selling. Most of the time, they are buying media based on a rough alignment between the simple, coarse consumer profiles—often only demographics—and geography-based—of the viewers and what they think they know about their own brand. As they are looking for ways to improve the effectiveness of the media they purchase, they need to be able to choose media options that align with audiences that have higher propensity to buy what they have to sell.

As such, there is significant demand for a dramatically improved set of media-assessment metrics that includes not only reach and coverage but actual purchase metrics. This will help media planners make informed media purchase decisions and bring effectiveness to the media buying process.

Furthermore, there is a natural demand to extend the use of such metrics beyond just planning and influence actual media campaign execution by utilizing these metrics for campaign measurements and optimization.

At the same time, marketers, advertisers, and publishers have been using third-party tracking cookies to deliver targeted media (e.g., content, including advertisement) to users. However, third-party tracking cookies are being blocked or will be blocked by default on many browsers. This is due in part to the greater desire and expectations by users that their personal information is being protected and kept private. Advertisers will no longer be able to rely on tracking cookies.

Similar pressures are being applied to mobile advertisement identifiers, or MAIDs (IDFA and AAID), the identifiers used to deliver targeted media in mobile applications (applications run on mobile devises such as smartphones or tablets). These identifiers are being made extremely difficult to be used for individual user targeting in mobile applications.

To protect user privacy, many major digital advertisement campaign delivery platforms (such as Google and Facebook) have stopped providing advertisement campaign information on individual user level (browser cookies, MAIDs) to their clients, advertisers. The only campaign information sent back to the advertisers is aggregated at cohort level: usually a group of hundred plus unique users.

There is a need for advertising targeting based on the aggregate, cohort-level, campaign feedback information that advertisers now receive from advertisement campaign delivery platforms.

### BRIEF SUMMARY OF THE INVENTION

A Purchase Media Metrics (PMM) Platform is a software platform that enables building, maintaining, and managing Purchase Media Metrics and using these metrics for ad campaign planning & insights generation, performance measurements, and optimization. PMM Platform empowers advertisers to plan their cohort-targeting campaigns in a privacy-safe manner using unique viewer-purchaser graph that connects media views with brand and category purchases. At the same time, the PMM Platform helps publishers/networks identify the best advertisers for their inventories and package and prioritize their media offerings. By further enriching the viewer-purchaser graph with campaign exposure data, the PMM Platform enhances advertisers' campaign measurement and optimization capabilities.

PMMs are metrics associated with sets of TV and digital media audiences. The metrics quantify attributes of these audiences that are related to each of thousands of specific brands and categories. These attributes could include the percentage of buyers of a particular brand, the level and range of consumer spend on this brand, the buying patterns, and others.

An analytics-as-a-service solution provides a comprehensive and standardized way of advertising media planning based on the combined consumer media viewership and product purchase dataset, the “Viewer-Purchaser” panel. The solution further provides extended to advertising campaign measurement and optimization by enriching the “Viewer-Purchaser” panel with media campaign exposure data to create the “Viewing-Purchasing-Campaign” panel.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a simplified block diagram of a client-server system and network in which an embodiment of the invention may be implemented.

FIG. 2 shows a more detailed diagram of an exemplary client or server computer which may be used in an implementation of the invention.

FIG. 3 shows a system block diagram of a client or server computer system used to execute application programs such as a web browser or tools for building an explore and exploit cohort optimization Platform according to the invention.

FIGS. 4-5 show examples of mobile devices, which can be mobile clients.

FIG. 6 shows a system block diagram of mobile device.

FIG. 7 shows a PMM-based side-by-side media package comparison report.

FIG. 8 shows an effect of view-time weighing of the buyer percentage and average spend per viewer PMMs.

FIG. 9 shows a block diagram of an implementation of the PMM Platform.

FIG. 10 shows examples of PMM requests supported by the Media Planning and Insights module.

FIG. 11 shows an example illustrating how Media Planning and Insights module executes client's request for PMM scores for a given brand/category and media selection.

### DETAILED DESCRIPTION OF THE INVENTION

FIG. 1 is a simplified block diagram of a distributed computer network 100 which embodiment of the present invention can be applied. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information.

Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, the client systems can run as a standalone application such as a desktop application or mobile smartphone or tablet application. In another embodiment, a “web browser” application executing on a client system enables users to select, access, retrieve, or query information stored by server system 122. Examples of web browsers include the Internet Explorer and Edge browser programs provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

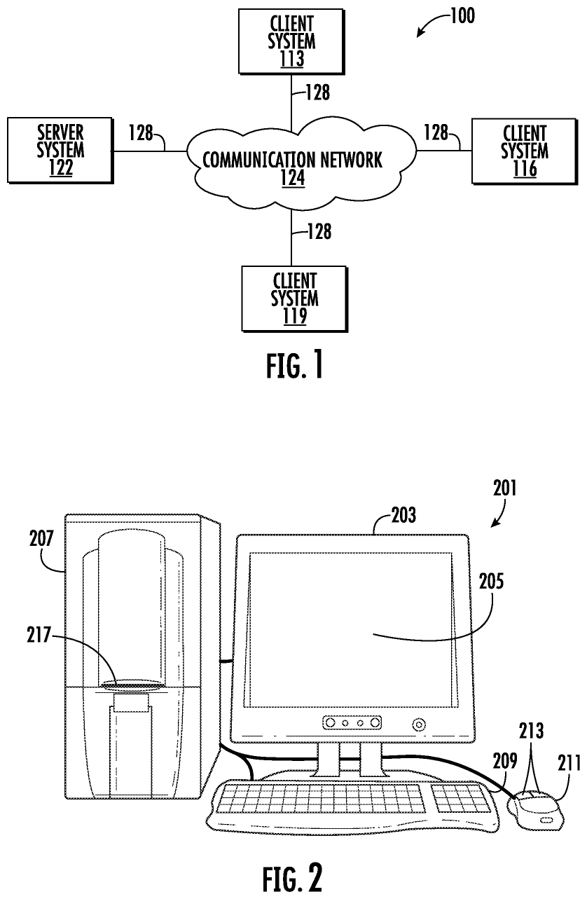

FIG. 2 shows an exemplary computer system (e.g., client or server) of the present invention. In an embodiment, a user interfaces with the system through a computer workstation system, such as shown in FIG. 2. FIG. 2 shows a computer system 201 that includes a monitor 203, screen 205, enclosure 207 (may also be referred to as a system unit, cabinet, or case), keyboard or other human input device 209, and mouse or another pointing device 211. Mouse 211 may have one or more buttons such as mouse buttons 213.

It should be understood that the present invention is not limited to any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iphone 12 and iPhone 12 Pro), Apple iPad (e.g., Apple iPad Air, Apple ipad Pro, or Apple iPad mini), Apple iPod (e.g., Apple iPod Touch), Samsung Galaxy product (e.g., Galaxy S series product or Galaxy Note series product), Google Nexus, Google Pixel devices (e.g., Google Pixel 5), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front facing camera or rear camera, or both) for taking pictures and video. For example, a smartphone or tablet can be used to take live video that can be streamed to one or more other devices.

Enclosure 207 houses familiar computer components, some of which are not shown, such as a processor, memory, mass storage devices 217, and the like. Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

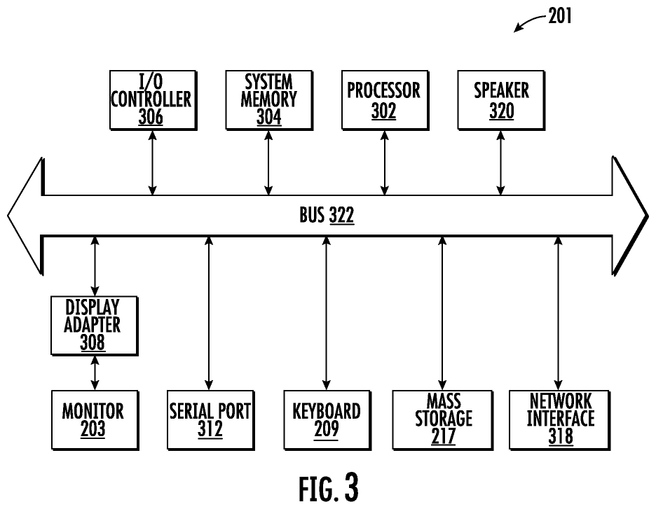

FIG. 3 shows a system block diagram of computer system 201 used to execute the software of the present invention. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from Math Works, www.mathworks.com), SAS, SPSS, JavaScript, AJAX, Python, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows 7, Windows 8, Windows 10, Windows CE, Windows Mobile), Linux, HP-UX, UNIX, Sun OS, Solaris, Mac OS X, Apple IOS, Android, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac (e.g., Wi-Fi 5), 802.11ad, 802.11ax (e.g., Wi-Fi 6), and 802.11af, just to name a few examples), near field communication (NFC), radio-frequency identification (RFID), mobile or cellular wireless (e.g., 2G, 3G, 4G, 5G, 3GPP LTE, WiMAX, LTE, Flash-OFDM, HIPERMAN, iBurst, EDGE Evolution, UMTS, UMTS-TDD, 1×RDD, and EV-DO). For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a web application from one or more servers using a network connection with the server or servers and load the web application in a web browser. For example, a web application can be downloaded from an application server over the Internet by a web browser. Nonnative applications can also be obtained from other sources, such as a disk.

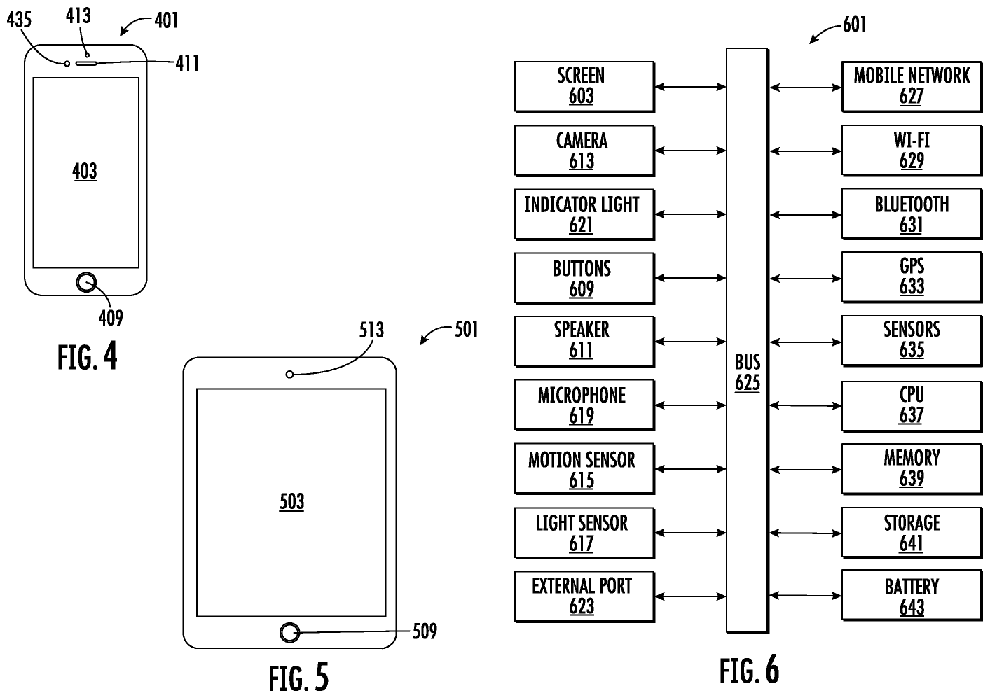

FIGS. 4-5 show examples of mobile devices, which can be mobile clients. Mobile devices are specific implementations of a computer, such as described above. FIG. 4 shows a smartphone device 401, and FIG. 5 shows a tablet device 501. Some examples of smartphones include the Apple iPhone, Samsung Galaxy, and Google Nexus family of devices. Some examples of tablet devices include the Apple iPad, Samsung Galaxy Tab, and Google Nexus family of devices.

Smartphone 401 has an enclosure that includes a screen 403, button 409, speaker 411, camera 413, and proximity sensor 435. The screen can be a touch screen that detects and accepts input from finger touch or a stylus. The technology of the touch screen can be a resistive, capacitive, infrared grid, optical imaging, or pressure-sensitive, dispersive signal, acoustic pulse recognition, or others. The touch screen is screen and a user input device interface that acts as a mouse and keyboard of a computer.

Button 409 is sometimes referred to as a home button and is used to exit a program and return the user to the home screen. The phone may also include other buttons (not shown) such as volume buttons and on-off button on a side. The proximity detector can detect a user's face is close to the phone, and can disable the phone screen and its touch sensor, so that there will be no false inputs from the user's face being next to screen when talking.

Tablet 501 is similar to a smartphone. Tablet 501 has an enclosure that includes a screen 503, button 509, and camera 513. Typically the screen (e.g., touch screen) of a tablet is larger than a smartphone, usually 7, 8, 9, 10, 12, 13, or more inches (measured diagonally).

FIG. 6 shows a system block diagram of mobile device 601 used to execute the software of the present invention. This block diagram is representative of the components of smartphone or tablet device. The mobile device system includes a screen 603 (e.g., touch screen), buttons 609, speaker 611, camera 613, motion sensor 615, light sensor 617, microphone 619, indicator light 621, and external port 623 (e.g., USB port or Apple Lightning port). These components can communicate with each other via a bus 625.

The system includes wireless components such as a mobile network connection 627 (e.g., mobile telephone or mobile data), Wi-Fi 629, Bluetooth 631, GPS 633 (e.g., detect GPS positioning), other sensors 635 such as a proximity sensor, CPU 637, RAM memory 639, storage 641 (e.g., nonvolatile memory), and battery 643 (lithium ion or lithium polymer cell). The battery supplies power to the electronic components and is rechargeable, which allows the system to be mobile.

A Purchase Media Metrics Platform, or PMM Platform, is a software platform that enables building, maintaining, managing, and using Purchase Media Metrics (PMM). These metrics are further used to plan media, as well as measure outcomes and optimize performance of TV and digital media advertising campaigns.

TV and digital media include, but are not limited, to the following media and devices as well as applications supported by these devices: Linear TV (LTV), Connected TV (CTV), Over-the-Top (OTT), Video on Demand (VOD), Streaming Video, Full Episode Players (FEP), OTT & CTV devices, Smart TVs, Social Media Influencers, Desktops, Mobile Phones, Tablets, and Browsers.

PMMs are fact-based metrics, both inferred statistics and forecasted predictions, associated with each of comprehensive sets of TV and digital media audiences. The metrics describe attributes of these audiences that are related to each of thousands of specific retail brands and categories. These attributes could include ‘presence of buyers’ or reach, the percentage or absolute number of buyers of a particular brand; the level and range of consumer spend on this brand, the buying patterns, and others.

When used for advertising campaign measurements and optimization, PMMs link audience exposure to the brand/category/product advertising campaign to purchases of the brand/category/product. These PMMs could describe attributes of the audiences that are related to specific advertising campaigns or campaign types that have been run (in the past), are being run (in the presence), or are planned to be run (in the future) for specific brands, categories, products by advertising agencies and advertisers themselves. These attributes could include the number of (or percentage of) buyers of a particular brand/category/product resulting from a particular advertising campaign, the level and range of consumer spend on this brand/category/product resulting from a particular advertising campaign, the number of buyers of a particular brand/category/product resulting from a particular advertising campaign—as the percentage of the total number of individuals/households exposed to this campaign, the level and range of consumer spend on this brand/category/product resulting from a particular advertising campaign—as the percentage of the total cost of this campaign, and others.

The metrics are designed to be used to plan TV and digital media purchases for advertising campaigns, to measure campaigns' outcomes, and to optimize campaign's performance. When used for campaign planning, the metrics provide advertisers and agencies with additional information about audiences-beyond the typical reach and demographic information provided by traditional audience intelligence and insights vendors (e.g., Nielsen and Comscore). The most important value of this information is that it is directly linked to consumer purchases, the ultimate business outcomes sought after by the advertisers.

The metrics could also be leveraged beyond media planning to power campaign measurement and optimization functionality. PMMs could not only be used to drive the creation of audience cohorts but also become the campaigns' KPIs against which the cohort performance is measured and further optimized. Similarly to the media planning case, when used for campaign performance and optimization, the metrics provide advertisers and agencies with ability to measure and optimize campaigns via metrics directly connected to consumer purchases, the ultimate business outcomes sought after by the advertisers. Furthermore, when using causal, or incremental, PMMs, such as the ones that measure incremental purchases and sales lift, advertisers and agencies measure and optimize campaigns based on the goals to bring only consumers who buy the brand/category/product only due to their exposure to the campaign ads, and not the consumers who would buy the brand/category/product anyway, with or without the ad campaign. This significantly reduces campaign costs and improves campaign efficacy.

In addition, sell-side players, such as publishers/networks, could use PMMs to help sell their ad media inventories. By linking the audiences of their ad media inventories to various brands and categories directly via the audiences' purchase behaviors, sell-side players better direct their sales effort and set and defend their media inventory prices-differentiated for specific brands and categories.

The information provided by PPMs becomes even more valuable as consumers' individual digital identifiers, third-party cookies and advertiser device IDs, are rapidly fading away under ever growing pressure from enhanced privacy laws and regulations and resulting limitations being imposed by major technology providers, both browser vendors (e.g., Apple Safari, Google Chrome, Mozilla Firefox) and mobile platforms (e.g., Apple and Google Android). The shrinking domain of consumers' individual digital identifiers results in increasing reliance by advertisers and agencies on cohort—and context-based decisioning—that naturally lends itself to enrichment via PMM.

PMMs exists as the nexus of two vast and granular data sets: purchase data (the Purchase Panel or Purchase Graph) and viewership data (the Viewership Panel)—when used for media planning by buy-side players or for support their ad inventory sales by sell-side players. When used for ad campaign measurement and optimization, a third data set, advertising campaign exposure data (the Ad Exposure Panel or Ad Impressions Panel), is joined to the other two data sets. Using its scalable infrastructure and unique statistical and machine learning algorithms, the PMM Platform sources, curates, normalizes and extracts valuable statistics, insights, and measurements from the massive volumes of purchase, viewership, and exposure data. The data sets are matched, in a privacy compliant way, at household or individual user level. The data sets (both individually and when combined) could be normalized to be statistically representative of advertiser-defined or -specified target audiences, geographies, and others—against key audience attributes used by advertisers, such as geography, demographics, and others.

One of the core values of PMM comes from the uniqueness of the underlying purchase data. This data comes at transactional level of granularity directly from reward program services provided to banks. The PMM Platform collects and manages a massive corpus of debit and credit purchase data, which accretes daily. This large panel of reward program cardholders could be preprocessed to eliminate biases. The panel is also “matchable”: it can be safely, in privacy preserving form, connected at the individual or household level to other data sets. Other (additional or alternative) sources of safely “matchable” transactional-level purchase data could be also used, e.g., the ones directly provided by the advertiser or by a co-op of advertisers.

The second type of data used in PMM is detailed viewership data, for TV and digital media channels. Source of viewership data could include automatic content recognition (ACR), software development kits (SDK), and server logs generated data. TV viewership data could include detailed logs of household TV viewing behaviors across multiple devices, complete with the network, program name, time and duration of viewing. Similar levels of granularity could be provided by digital viewership/site visits data. This data is made available by various players in the TV and digital media industries. This data could also be preprocessed to eliminate biases and is also safely “matchable”: it can be connected at the individual or household level to other data sets in privacy preserving form.

By matching the viewership data set with the purchase data set, the PMM Platform creates a large panel of consumers informed by both viewing and purchase histories, the Viewer-Purchaser” panel.

This “Viewer-Purchaser” panel could be then aggregated (rolled up) along the viewership and purchase dimensions. For example, in the case of linear TV media, the aggregation dimensions could include Network, Program, and Time of watching (Daypart, a combination of time of day or hour and day of week or date), as viewership dimensions, and product Category and Brand, as purchase dimensions. In another example, in the case of online, in-browser, media, the viewership dimensions could include Publisher, Site, and Time of viewing (Daypart).

Depending on the aggregation rules, the resulting data sets, the aggregated “Viewer-Purchaser” graphs, could have different granularity levels and different dimensions present. Under some aggregation rules, the resulting data sets could have individual users (person or household IDs) aggregated out. Such aggregated “Viewer-Purchaser” graph could be viewed as a table with millions of rows (data records), each keyed by Cartesian product of the viewership and purchase dimensions and containing a few dozen reach and spend metrics, including Media-Only Metrics (general, purchase independent, viewership metrics), Purchase-Only Metrics (general, viewership independent, purchase metrics) and Purchaser Media Metrics (connecting viewership and purchase). In the example of the linear TV media, with the aggregation dimensions of Network, Program, and Daypart—as the viewership dimensions and Category and Brand—as the purchase dimensions, these metrics could include: (a) Media-Only Metrics, such as (1) viewership audience size: number of viewers, (2) average viewing time as the percentage of the Program duration, and (3) average number of program viewers per second of the program; (b) Purchase-Only Metrics, such as (1) purchaser audience size: number of purchasers, (2) spend amount, and (3) average spend amount per purchaser; and (c) Purchase Media Metrics, such as (1) number of Brand buyers in the audience, (2) Brand dollar spend by the audience, (3) number of Brand purchase transactions by the audience, (4) percentage of the audience who are Brand buyers, (5) average Brand dollar spend across the entire audience, (6) average number of Brand purchase transactions across the entire audience, (7) the audience as the percentage of all Brand byers, (8) the audience spend as the percentage of all Brand dollars, (9) the number of audience transactions as the percentage of all Brand transactions, (10) average size of a Brand transaction among Brand buyers in the audience, (11) Brand reach index: the percentage of Brand buyer in the audience compared to that across all linear TV, (12) Brand spend index: the average Brand spend for the audience compared to that across all linear TV, (13) Brand number of transactions index: the average number of Brand transaction for the audience compared to that across all linear TV, (14) Brand transactions size index: the average Brand transaction size for the audience compared to that across all linear TV.

As described elsewhere in this application, the “Viewer-Purchaser” graph could be balanced to be statistically representative of advertiser-defined or -specified target audiences, geographies, and others—against key audience attributes used by advertisers, such as geography, demographics, and others.

The “Viewer-Purchaser” graph could generate thousands of specific “audiences,” cohorts of consumers, by including or excluding viewership and purchase dimensions and/or selecting ranges of the metrics. Such cohorts are “natural,” selected via viewing and buying behaviors only—without any additional audience constraints. These cohorts are the sets of households or individuals specified entirely by the way they view media (e.g., watch a program or visit a site) and purchase category/brand products. These cohorts could be classified as viewership-centric cohorts, purchase-centric cohorts, or mixed cohorts.

Viewership-centric cohorts group audiences based on their viewing habits. Members of such cohorts are consumers who have propensities to view specific Networks/Programs or visit specific Publishers/Sites. Members of such cohorts are specified by a combination of the viewership dimensions and a threshold or range of a consumer-level Media-Only Metric, e.g., in a Linear TV case, viewing time or viewing time as the percentage of the Program duration. In this case, members of such cohorts could be specified as, e.g., consumers who have watched specific programs on specific networks for at least X seconds during specific time interval, where X is the minimum viewing time. These cohorts are analyzed and scored for purchase behavior and a set of brand and category-specific PMMs are created for each viewership-centric cohort against each of thousands of brands and categories. These cohorts could then be easily used by advertisers and agencies who could select a threshold for a PMM (or a combination, e.g., a weighted sum, of PMMs), such as the minimum reach or minimum consumer spend, for their brands and categories and receive the list of viewership-centric cohorts that meet this criterion, as well as estimated values of key PMMs for each selected cohort and/or for the combined audience (the audiences aggregated across the selected cohorts), e.g., absolute reach and consumer spend metrics, such as the total number of buyers or the total consumer spend for the combined audience, or relative reach and consumer spend metrics, such as the total number of buyers of the combined audience or the total consumer spend of the combined audience divided by the size of the combined audience. This would guide the advertisers and agency decisions about where and when to buy their audiences. The advertisers and agencies could modify their plan by excluding/including specific viewership-centric cohorts until they reach the optimal balance of absolute or relative reach and spend metrics.

A plan optimization functionality could be available for an advertiser or agency. The advertiser/agency could select a goal and constraints and a constraint optimization program would generate an optimal mix of viewership-centric cohorts. Examples of such constrained optimization programs could include the following: maximize the relative consumer spend subject to the absolute reach being above X and exclusion of networks A, B & C, inclusion of program Y, and exclusion of overnight daypart; maximize the absolute reach subject to consumer spend being above Y and exclusion of networks A and B during weekends; and others.

Purchase-centric cohorts provide an audience segmentation complementary to viewership-centric cohort. Purchase-centric cohorts divide audiences based on their purchase propensities. Members of such cohorts are consumers who have propensities to buy specific brands, categories, and products. Members of such cohorts are specified by a combination of the purchase dimensions and a threshold or range of a consumer-level Purchase-Only Metric, e.g., spend amount or spend amount per purchaser for the Brand/Category. In this case, members of such cohorts could be specified as, e.g., consumers who have spent at least X dollars on specific category of specific brand during specific time interval, where X is the minimum spend amount. These cohorts are analyzed and scored for viewership behavior and a set of viewership-type-specific (e.g., a specific network, program, and daypart combination in the case of the Linear TV) PMMs are created for each purchase-centric cohort against each of thousands of viewership-type combinations. These cohorts could then be easily used by networks/publishers who could select a threshold for a PMM (or a combination, e.g., a weighted sum, of PMMs), such as the minimum reach or minimum consumer spend, for their programs/sites and receive the list of purchase-centric cohorts that meet this criterion, as well as estimated values of key PMMs for each selected cohort and/or for the combined audience (the audiences aggregated across the selected cohorts when, for example, creating an offer to an advertiser and aggregating across all purchase-centric cohorts centered around the advertiser's brands and/or products), e.g., absolute and/or relative reach and/or consumer spend metrics. This would help the networks/publishers and sell-side aggregators to decide on to which advertisers to sell their media, as well as on packaging, pricing, and prioritizing advertising media inventory offerings to these advertisers.

The networks/publishers and sell-side aggregators could create advertiser specific bundles by combining the purchase-centric cohort audiences across the networks/publishers' programs/sites/dayparts and across advertiser's categories and brands. Similarly, networks/publishers and sell-side aggregators could create agency specific bundles by combining the purchase-centric cohort audiences across the networks/publishers' programs/sites/dayparts and across agency's advertisers' categories and brands (and projecting them on their viewership space). The networks/publishers and sell-side aggregators could modify their bundles by excluding/including specific purchase-centric cohorts until they reach the optimal balance of absolute and relative reach and spend metrics.

Prioritized media offerings and bundle optimization functionality could be available for a network/publisher. The network/publisher could select a goal and constraints and a constraint optimization program would generate an optimal mix and priority order of purchase-centric cohorts and bundles. An example of such constrained optimization programs could include the following: maximize the absolute reach subject to consumer spend being above Y and exclusion of brands A, B & C, exclusion of programs R, S, T, and inclusion of brand Y.

Mix cohorts provide the most flexible audience segmentation approach allowing to create audiences based on both viewership and purchase attributes. This approach allows the user to create cohorts based on any combination of the dimensions and metric ranges. Mix cohorts divide audiences based on both their viewing habits and their purchase behavior or propensities. Members of such cohorts are consumers who have both propensities to view specific Networks/Programs or visit specific Publishers/Sites and propensities to buy specific Brands and Categories. Members of such cohorts can be specified by a combination of the viewership and purchase dimensions. In this case, members of such cohorts could be specified as, e.g., consumers who (i) have watched specific programs on specific networks for at least X seconds during specific time interval, where X is the minimum viewing time, and (ii) have spent at least Y dollars on specific category of specific brand during specific time interval, where Y is the minimum spend amount.

The user, either an advertiser/agency or publisher/network, could create either prescribed cohorts, based on human expertise and intuition, or learned cohorts, as solutions of constrained optimization programs maximizing various consumer spend and reach metrics (or their combinations) and subject to constraints of other consumer spend and reach metrics being above user specified thresholds and inclusion or exclusion of user specified dimension values.

The media identifiers (e.g., the network, program, and daypart identifiers in the case of the Liner TV example) could be directly connected to the programming data/media inventory data used by that platform as various media packages are assembled and reviewed by media buyers, so that the associated category/brand reach and spend metrics may become available and used in the planning process. In this case, category's/brand's media planners have direct access to consumer purchase metrics linked to media inventory, additional valuable information-beyond just standard reach and demographics provided by traditional audience intelligence and insights vendors—about the ad slots they are buying.

As discussed elsewhere in this application, PMMs could be used to directly specify the audience selections (rather than to score an existing, already created, audience) and create viewership-centric cohorts, purchase-centric cohorts, or mixed cohorts. For example, a PMM score attached to a piece of media can be used to make a direct recommendation of media selection and linking this piece of media to viewership-centric cohorts. Under this use case, PMMs are used as brand or category-based scores attached to media inventory/programming slots, based entirely on the “natural” (selected via viewing and buying behaviors only) cohorts of households or individuals—as described elsewhere in this application.

For marketing and advertisement purposes, households and individual consumers, however, could be grouped in many different ways based on different rules and attributes, e.g., by demographics, by geography, and others, and driven by different campaign goals. Brand/category affinity's audience scoring-via the measurement of brand/category spend within an audience group-could, in practice, be applied to any arbitrary set of households or consumers.

PMM metrics of “natural” cohorts—sets of households and consumers grouped together based on what they are watching and what they are buying only, with no additional input to modify these viewership- and purchase-based cohorts—are referred to as the PMM “Reference Data Set.”

A PMM score attached to a piece of media can be used to make a direct recommendation of media selection, if the campaign goals are aligned with PMM, e.g., the goal of maximizing the number of buyers of brand X. The PMM “Reference Data Set”—without any additional “overlay” of the audience definition—can be very useful in this situation. If an advertiser is looking for brand X shoppers, they can select media slots (e.g., network/publisher, program/site, daypart) with the highest PMM “Reference Data Set” scores for brand X (e.g., network/publisher, program/site, daypart) to engage consumers.

As campaigns could have various audience goals, some of them do not always directly align with PMM metrics and require segmentations based on attributes of individuals rather than those of media, e.g., the goal of maximizing awareness among millennials. This usually results in more complex desired audiences. When advertisers have additional goals for their campaigns that go beyond simply a desire to reach certain buyers, a pre-defined addressable audience (e.g., a list of IDs) could be used against the “Viewer-Purchaser” panel, e.g., its connected TV or web site projection, to provide a PMM on each media program/site showing what portion of the viewers are (a) in the defined or specified audience and also purchase the selected brand; (b) not in the defined or specified audience but still purchase the selected brand. This PMM could be considered a “Custom Media Score,” e.g., the score that is still attached to the “media” (the program/site) but is now refined to consider the subset that is (or is not) advertiser's defined or specified audience.

The Platform's purchase data, connected to both consumer ID and viewing data, could be used at a higher level to score any audience/media combination at any level. This use case has added requirement of flexible ID graph matching—each audience list fed to the platform could be a mix of hashed email addresses, cookies, MAIDs, IP addresses, and others.

In the situations when campaigns have audience goals not directly aligned with PMM metrics—as described elsewhere in this application—and in some other cases, PMM could be positioned as a measure/score of existing media and audience selections, rather than as a driver of programmatic or direct audience selections.

The PMM Platform is able to take media plans and specific audience selections as input and provide customized feedback to media planners. This feedback allows them to compare different media tactics, packages and bundles and make judgement calls regarding actual audience spend vs. media placement costs. The PMM Platform could be directly integrated into the existing media planning workflow of the advertiser or agency and, thus, deliver this information directly into systems currently used by media planners.

In this case, the PMM Platform serves as a marketing decision tool—the validation component, which stands apart from—and is not influenced by—either the buy side or the sell side of the advertising ecosystem. As such, PMM becomes an independent informative yardstick of truth that can be easily applied to any form of audience selection.

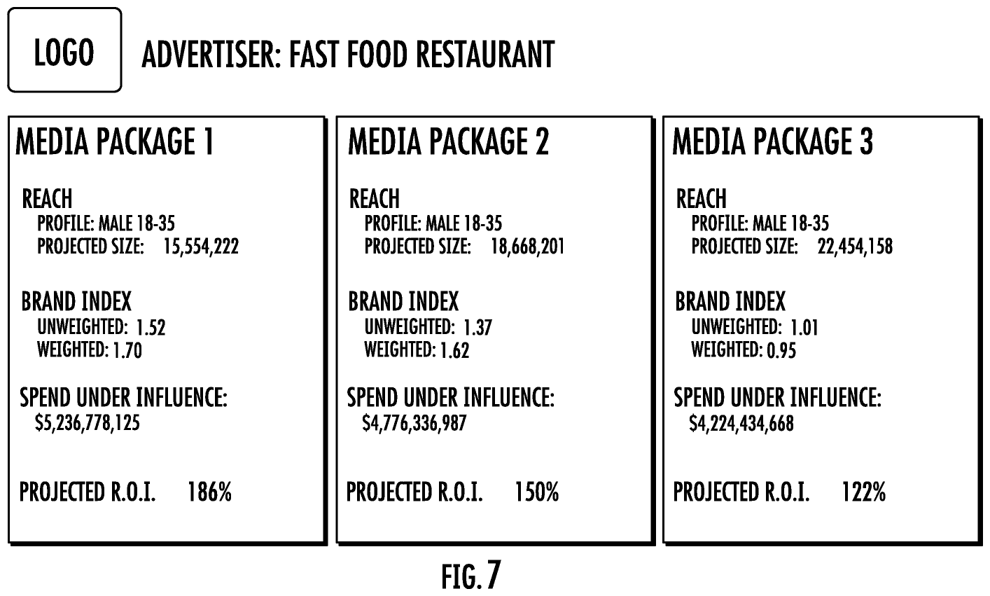

FIG. 7 shows an example of using PMM to score the media already selected based on different criteria during a media planning/purchase process. Looking at the side-by-side comparison report presented in FIG. 7, the media planner will quickly learn that, even though Package 1 seems less attractive when looking at the Reach numbers alone, it presents a better overall influence opportunity for the client because of the Brand Preferences of the audience.

The advertiser's media planner could use the Platform to get an assessment of an audience or media plan, the information on which to base a media purchasing decision. The Platform gives the planner the insight they need to feel confident that they have made the right audience or media selections and/or help make informed audience or media decision among several options.

In one implementation of the Platform, the Planner first needs to select (a) Category (e.g., QSR) and Brand (e.g., McDonalds) and (b) the advertiser selected audience(s)—received by the Platform from the advertiser's or 3^{rd} party audience management system, (e.g., CDP, DMP, and others), with which the Platform is integrated. In addition, the Planner could also select media choices, e.g., bundles/packages and/or media types (Linear TV/CTV/Display/Mobile/Social) and/or Networks/Publishers and/or Programs/Sites. Then the Planner could request and receive back several types of media-audience insights, such as (a) given specific media choice(s), show “Custom Media Score” PMMs for advertiser selected audience(s), or (b) given specific advertiser selected audience choice(s), show “Custom Media Score” PMMs for the available media choices.

The Planner is also able to compare “Custom Media Score” PMMs, based on media selection constrained to advertiser selected audience(s), against PMM “Reference Data Set,” based on unconstrained media selection-without any external audience overlay.

The Planner could apply additional constraints on calculating PMM, such as Geo Focus (e.g., Country, State/Province, DMA, and others), Time Focus (Part of Day, Day of Week), frequency/recency of purchases, lookback window for media/use of attention metrics based on viewing time, and others.

PMMs are metrics that show (i) presence of brand purchasers, level of brand spend, number of brand transactions, and other brand purchase behavior characteristics (for a specific combination of one or multiple brands and/or categories) (1) across media viewing audience and (2) across media non-viewers (for a specific combination of one or multiple networks and/or programs and/or episodes and/or dayparts) as well as (ii) presence of media viewers, media viewing time, number of media viewing instances, and other media viewing behavior characteristics (for a specific combination of one or multiple networks and/or programs and/or episodes and/or dayparts) (1) across brand purchasers and (2) across brand non-purchasers (for a specific combination of one or multiple brands and/or categories).

These metrics could take different forms. As described elsewhere in this applications, the following factors and their combinations define different types of PMMs: (a) input variables (primary metrics) used in PMM construction: e.g., (i) transaction spend amount, total (aggregated) spend amount, total (aggregated) number of transactions, presence of purchasers, total (aggregated) number of purchasers (ii) media viewing instance time length, total (aggregated) media viewing time, total (aggregated) number of media viewing instances, presence of media viewers, total (aggregated) number of media viewers (the size of the media viewing audience); (b) expressions used in PMM construction: e.g., counts, sums, percentages, ratios, indices, geospatial averages, time averages, as well as weighted averages and totals (weighted by decay factors, viewing time, spend, and others); (c) overlayed constraints: audiences (demographics, behaviors, lists of IDs, and others), geography (e.g., Country, State/Province, DMA, and others), time (Part of Day, Day of Week, windows, and others); (d) transformation and normalization: e.g., balancing to match specific audience composition (e.g., projection onto national or specific geographical level, such as state or province), pre-aggregations (e.g., at household level).

The following are examples of percentage and ratio PMM metrics—for given media A (a specific combination of one or multiple networks and/or programs and/or episodes and/or dayparts) and brand X (a specific combination of one or multiple brands and/or categories): (i) purchase behavior metrics: (1) viewer metrics: (a) purchaser percentage among viewers: [Total number of purchasers of brand X among all viewers of media A] divided by [Total number of viewers of media A], (b) average spend per viewer: [Total spend on brand X among all viewers of media A] divided by [Total number of viewers of media A], (c) average number of transactions per viewer: [Total number of transactions of brand X among all viewers of media A] divided by [Total number of viewers of media A], (d) average basket size of a viewer: [average spend per viewer] divided by [average number of transactions per viewer]; (2) non-viewer metrics: the same as the viewer metrics (a)-(d) of (i)(1) above where viewer is replaced by non-viewer; (ii) media viewing behavior metrics: (1) purchaser metrics: (a) viewer percentage among purchasers: [Total number of viewers of media A among all purchasers of brand X] divided by [Total number of purchasers of brand X], (b) average media viewing time per purchaser: [Total viewing time of media A among all purchasers of brand X] divided by [Total number of purchasers of brand X], (c) average number of viewing instances per purchaser: [Total number of viewing instances of the media A among all purchasers of brand X] divided by [Total number of purchasers of brand X], (d) average length of the viewing time per viewing instance of a purchaser: [average media viewing time per purchaser] divided by [average number of viewing instances per purchaser]; (2) non-purchaser metrics: the same as the purchaser metrics (a)-(d) of (ii)(1) above where purchaser is replaced by non-purchaser.

Various constraints could be applied to these metrics: specific purchasing period, e.g., one month; different time ranges for purchases around the viewing point, e.g., two weeks before, month before, quarter before, year before, two weeks after, month after; minimal number of transactions in definition of buyer, e.g., 1 transaction per period; minimum spend in definition of buyer, e.g., $5 per period; minimum viewing time in definition of viewer, e.g., 5 minutes; and others.

Weights could be used in definitions of percentage and ratio PMM metrics, e.g., the length of time the program was viewed by a person could be used as a weighting factor on their purchase behavior. E.g., transaction activity for those who watch more is weighted more heavily.

The viewer engagement weighting (weighting by viewing time) concept takes into consideration the degree to which individual viewers are engaged with the program. For example, if during a given time frame Viewer A watches Program P for 30 minutes, while Viewer B watches Program P for 300 minutes, Viewer B's purchase behavior should be weighted 10 times more than Viewer A in calculating the average purchase behavior among viewers of Program P.

Thus, a time-weighted purchase profile averages for any program or collection of programs could be calculated as follows:

Brand Spending Average for Specific Program(s)=sum(Total_Brand_Spending*Total_Viewing_Time) across entire program(s) audience/sum(Total_Viewing_Time) across entire program(s) audience (Formula 1)

Brand Presence Average for Specific Program(s)=sum(Brand_Buyer*Total_Viewing_Time) across entire program(s) audience/sum(Total_Viewing_Time) across entire program(s) audience (Formula 2)

The values here can be interpreted as the weighted average spending on the brand, and the weighted proportion of brand buyers in the program(s) audience, for all programs and brands within scope.

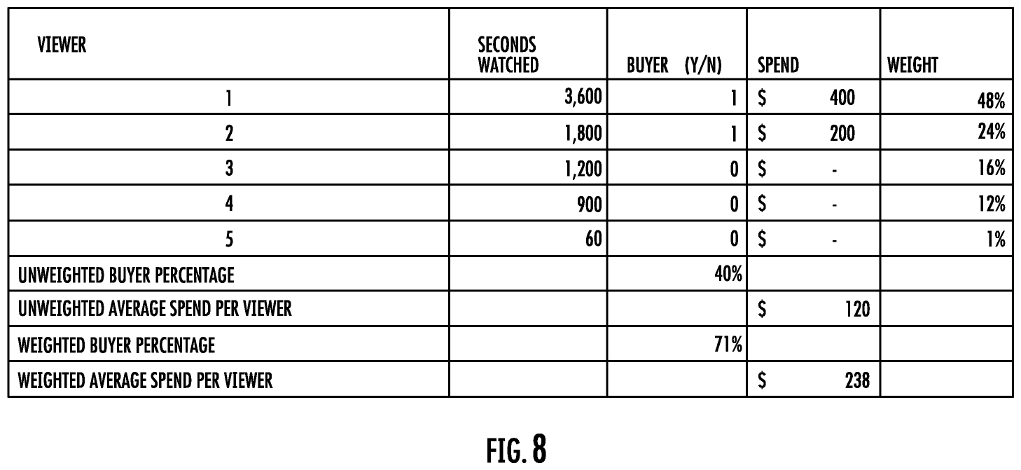

A hypothetical example of a 5-viewer program audience illustrates the effect of viewer engagement weighting (time watched) on PMMs (see FIG. 8). The unweighted buyer brand presence is 40 percent; but because buyers are much more engaged with the program, the weighted average is more than 70 percent. Similarly, the unweighted average brand spend per viewer is $120; but weighted average brand spend per viewer increases to $238.

Similarly, spend amount could also be used in definitions of percentage and ratio PMM metrics, e.g., the spend on the brand of a consumer could be used as a weighting factor on their viewing behavior.

Index metrics could be constructed from percentage and ratio metrics by dividing a percentage/ratio metric for a specific program by that for the total viewership. The following are examples of index PMM metrics: average spend index: [Average spend per viewer-on Brand X for program A] divided by [Average spend per viewer-on Brand X of all Liner TV viewers], basket size index: [Average basket size for Brand X for program A] divided by [Average basket size-on Brand X of all Liner TV viewers], and others.

View engagement weighted measures (weighted by viewing time) at program(s) level described above can be indexed against view engagement weighted measures at the base viewership level. Examples of base viewership could be all liner TV viewers or all cable TV networks viewers.

Similar formulas to ones used for calculations of time-weighted purchase profile averages for specific programs or collections of programs (formula 1 and formula 2 above) should be used for calculations of time-weighted purchase profile averages for base viewership:

Brand Spending Average for Base Viewership=sum(Total_Brand_Spending*Total_Viewing_Time) across entire base viewership/sum(Total_Viewing_Time) across entire base viewership (Formula 3)

Brand Presence Average for Base Viewership=sum(Brand_Buyer*Total_Viewing_Time) across entire base viewership/sum(Total_Viewing_Time) across entire base viewership (Formula 4)

Then a time-weighted purchase profile indexes for any program or collection of programs could be calculated as follows:

Brand Spending Index=100*(Brand Spending Average for Specific Program(s))/(Brand Spending Average for Base Viewership) (Formula 5)

Brand Buyer Presence Index=100*(Brand Presence Average for Specific Program(s))/(Brand Presence Average for Base Viewership) (Formula 6)

Where Brand Spending Average for Specific Program(s), Brand Presence Average for Specific Program(s), Brand Spending Average for Base Viewership, and Brand Presence Average for Base Viewership are defined in formulas 1, 2, 3, and 4, respectively.

These View engagement weighted indexes provide a convenient way of indicating whether a program(s)′ audience has an above average (>100) or below average (<100) concentration of brand spending and brand buyer presence compared to a baseline.

For example, if in the hypothetical case of a 5-viewer program audience illustrated in FIG. 8 the index base viewership is defined as the total viewership of all cable TV networks, the Brand Spending Average for Base Viewership is $186, and Buyer Presence Average for Base Viewership is 57%, we can then use formulas 5 and 6 to compute Brand Spending and Brand Buyer Presence Indexes:

Brand Spending Index=100*($238/$186)=128 (Formula 7)

Brand Buyer Presence Index=100*(71%/57%)=125 (Formula 8)

This means that an average viewer of the program spends 28% more on the brand than an average audience across all cable TV networks and have a corresponding 25% higher concentration of brand buyers.

As part of data normalization, the purchase panel, and/or the viewership panel, and/or the viewer-purchaser panel could be balanced against different target populations (ground truth), e.g., census or other data sets of general population or of the viewership of specific media, constrained to specific geographic regions, and others.

The balancing could be performed (i) against various balancing factors, such as geography (e.g., state/province, DMA), demographics (e.g., age, gender, education level, household income), and others and (ii) at different balancing levels (e.g., Individual or Household).

Various sample balancing methods could be used, such as Iterative Proportional Fitting (IPF) or Naszodi-Mendonca method (NM-method).

For example, to derive a less biased brand purchase estimates for the Liner TV viewers based on the Viewer-Purchaser panel, a national advertiser might want to balance the Viewer-Purchaser panel against the total population of Liner TV viewers at national level (the target population). The advertiser could select DMA, Age Group, and Gender Group as balancing factors and Household as balancing level.

In addition to Media Planning use case, the PMM Platform also supports Measurements and Optimization use case. To support measurements and optimization, the PMM Platform incorporates additional data sets, in particular advertising campaign exposure data, such as impressions/exposures to advertisement, including advertiser spend, e.g., CPMs, (provided by publishers/networks/exchanges/SSPs/DSPs). This data set is joined with the Platform's “Viewer-Purchaser” panel at the individual or household level. This enriched, “Viewing-Purchasing-Campaign” dataset is then transformed into “Viewing-Purchasing-Campaign” panel that allows the Platform to support campaign measurement and optimization functionality in addition to campaign planning functionality. This allows to establish campaign performance feedback loops and, thus, enable dynamic cohorts—continuously learning and optimized intra-(short term) and inter-(long term) campaign via ongoing flow of campaign performance signals. This also allows to improve campaign planning stage by enabling (1) actual, ad impression/exposure based, reach, in addition to the absolute, viewership based, reach (that conflates both exposed and unexposed media views), and (2) incremental, caused by exposures to the campaigns' ads, purchases, in addition to the total purchases (that conflates both organic and advertising driven purchases).

The PMM Platform can serve different players in the TV and digital advertising ecosystem differently. Most notably, the Buy Side (Brands, Agencies) could use PMM scores to pressure sellers for lower CPMs, while the Sell Side (publishers, networks) could use PMM scores to set and defend higher CPMs. SSPs and DSPs could use PMM scores to arbitrate for profit.

The Buy Side (brands, agencies) require product-(brand-, category-) first approach: given my products (brands, categories) find me the media (networks/publishers-programs/sites) with viewers over indexed on my products (percentage of product buyers, spend amount on products, etc.).

The Sell Side (publishers, networks) require media-(networks/publishers-programs/sites-) first approach: given my media (networks/publishers-programs/sites) find me the products (networks/publishers-programs/sites) for which viewers of my media are over indexed (percentage of product buyers, spend amount on products, etc.).

In addition, the Buy Side (Brands, Agencies) use PMM scores for ad campaign measurement and optimization.

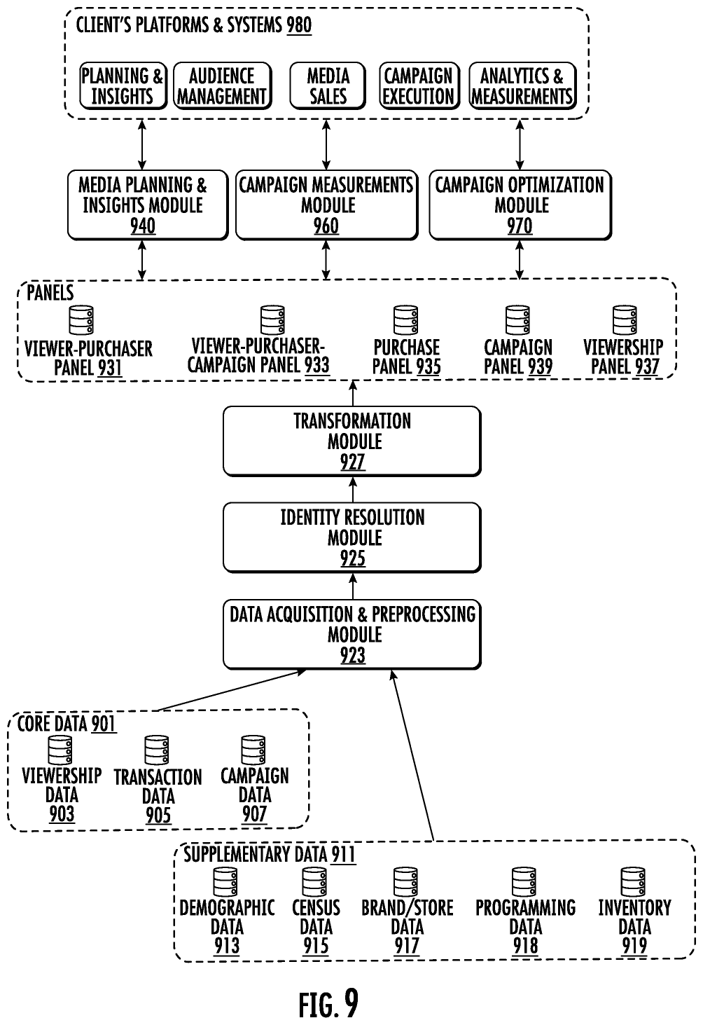

FIG. 9 shows a block diagram of one implementation of an the PMM Platform. The PMM Platform consists of 6 key modules: Data Ingestion and Preprocessing 923, Identity Resolution 925, Transformation 927, Media Planning and Insights 940, Campaign Measurements 960, and Campaign Optimization 970.

The first 3 modules, Data Ingestion and Preprocessing 923, Identity Resolution 925, Transformation 927 are “internal” modules. Their main task is to manage (build, update, and maintain) “Viewer-Purchaser” 931 and “Viewer-Purchaser-Campaign” 933 panels, as well as purchase 935, viewership 937, and campaign 939 panels.

The remaining 3 modules, Media Planning and Insights 940, Campaign Measurements 960, and Campaign Optimization 970, are “external modules.” Their main task is to directly communicate with the clint's Platforms & Systems 980 to support planning, measurements, and optimization of client's campaigns by leveraging the panels built by the first 3 modules.

The Data Ingestion and Preprocessing module 923 ingests both core 901 and supplementary data 911.

The core data 901 includes Viewership data/Media Viewership data 903, Transaction/Purchase data 905, and Campaign/Exposure/Impression data 907. The core data 901 arrives at individual or household level. The core data is used to build purchase 935, viewership 937, and campaign 939 panels and, eventually, “Viewer-Purchaser” 931 and “Viewer-Purchaser-Campaign” 933 panels.

Viewership data/Media Viewership data 903 arrives at individual viewing instance level of granularity as a set of individual viewing instance's attributes, often referred to as a viewing instance record. Each viewing instance record contains at least the following attributes: (a) user identifier attributes: viewer ID, (b) time attributes: viewing start timestamp and/or viewing end timestamp, (c) categorical attributes: network/network ID and/or program/program ID and/or episode/episode ID and/or daypart/daypart ID, and (d) quantitative attributes: viewing time length;

In some situations, the viewing time length is not an attribute of viewing instance records but both the viewing start timestamp and viewing end timestamp are attributes of viewing instance records so that the viewing time length has to be calculated as the difference between the viewing end timestamp and viewing start timestamp.

Transaction/Purchase data 905 arrives at individual transaction level of granularity as a set of individual transaction's attributes, often referred to as a transaction record. Each transaction record contains at least the following attributes: (a) user identifier attributes: purchaser ID, (b) time attributes: transaction timestamp and/or transaction date and/or other time identifier, (c) categorical attributes: brand/brand ID and/or category/category ID, and (d) quantitative attributes: at least transaction spend amount.

The supplementary data 911 includes third-party (3P) demographic data 913 (at individual or household level) and census data 915 (at geo level)—used for balancing and normalization; brand/store data 917—used for brand/store specific normalization; programming data 918 (for Linear TV) and inventory data 919 (cost, CPMs, and availability at site/program level—provided directly by sell-side players)—for planning/media placement recommendations.

The ingested data is cleansed and unified into consumer panels. The identity resolution service 925 is used to match the Viewership 903, Transaction 905, and Campaign 907 data on individual-person/household IDs to create the Viewership 937, Purchase 935, and Campaign 939, as well as the Viewer-Purchaser 931 and Viewer-Purchaser-Campaign 933 panels.

Under one implementation, some datasets stored within Viewership 937, Purchase 935, and Campaign 939 panels data storages have bypassed the identity resolution service 925 and, thus, are stored with their original IDs: viewer IDs, purchaser IDs, and media campaign user IDs. Identity resolution for these datasets happens later, when they need to be combined with another dataset with IDs from different ID space.

The identity resolution service 925 is also used to match the 3P demographics data 913 with the Viewer-Purchaser 931 and Viewer-Purchaser-Campaign 933 panels on individual-person/household IDs to balance the panels. Viewership data 903 is also matched with programming data 918 (for Linear TV) and inventory data 919 on Program IDs.

The Identity Resolution service 925 maps various type of individual/household identifiers (IP addresses, MAIDs, HEMs, PII) to universal individual/household IDs. The service could be realized via the Identity Graph hosted by the Platform but maintained and updated by a 3P provider or as an external service provided by identity resolution vendors, e.g., LiveRamp.

The Identity Resolution service 925 is used to connect the data sets containing individual/household identifiers, such as Viewership data 903, Transaction data 905, Campaign data 907, 3P demographic data 913, as well as audiences (lists of IDs) provided by clients.

The Transformation module 927 normalizes and balances the purchase 935, viewership 937, viewer-purchaser 931, and viewer-purchaser-campaign 933 panels against different target populations (ground truth), e.g., census or other data sets of general population or of the viewership of specific media, constrained to specific geographic regions, and others. Various supplementary data sources, such as 3P demographic data 913, census data 915, and brand/store data 917 are used by this module.

The Media Planning and Insights module 940 is engaged by the client, advertiser or publisher, for media exploration & insights, cohort building, audience validation, and campaign planning activities. The module also could be used by publishers/networks to support their inventory sales efforts as described elsewhere in this application.

The advertiser can access the module either programmatically via API or manually via GUI. The module could be directly integrated with the client's audience management platform (e.g., DMP, CDP, and others) and Media Sales/Media Buying/SSP/DSP platforms.

The client's audience management platform could have interactive access to the module via API to request and receive PMM scores for exploration and cohort building. The client sends to the module some combination of the following: (a) the targeted brand/category/product, (b) media type, set of included/excluded networks-programs/publishers-sites, (c) targeted audience (the list of IDs), (d) other campaign parameters, such as start date, end data, geographical constraints, daypart constraints, and others. The client receives back PMM scores for the received selections for all pertinent media inventory sources. The received feedback is used by the audience management platform to adjust media selections and/or modify the targeted audience. Ultimately, this results in the marketing media plan (selection of programs/sites) creation and deployment through DSPs/other Media Buying platforms.

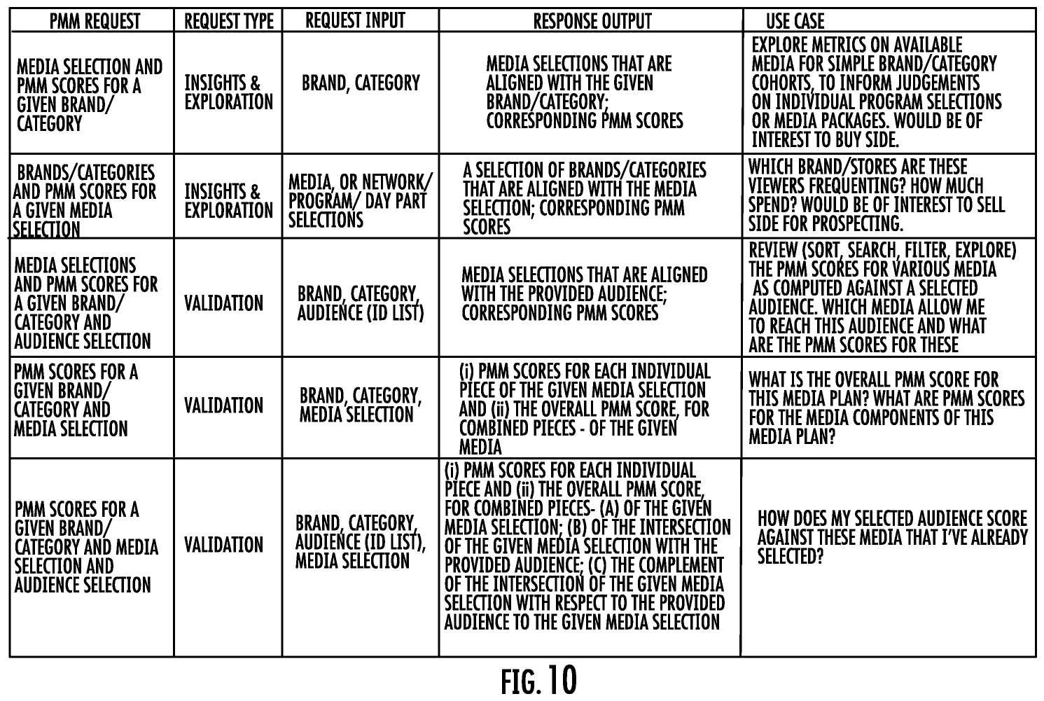

Examples of PMM requests supported by the module include, (i) Insights & Exploration requests, such as (a) Media Selection and PMM scores for a given Brand/Category and (b) Brands/Categories and PMM scores for a given Media Selection, and (ii) Validation requests, such as (a) Media Selections and PMM scores for a given Brand/Category and Audience Selection; (b) PMM scores for a given Brand/Category and Media Selection; (c) PMM scores for a given Brand/Category and Media Selection and Audience Selection. Details of these examples are presented in FIG. 10.

When the module receives client-built audiences, the module matches the received client-built audiences with the Viewer-Purchaser Panel 931 and/or Viewer-Purchaser-Campaign Panel 933 by using the Identity Resolution service 925.

The Media Planning and Insights module 940 calculates various PMM scores by querying the viewer-purchaser 931 and viewer-purchaser-campaign 933 panels. These queries are constructed based on various requests received from clients-advertisers, agencies, publishers, networks, and others, as well as on either event-driven or scheduled specific tasks being performed by the module—as described elsewhere in this application.

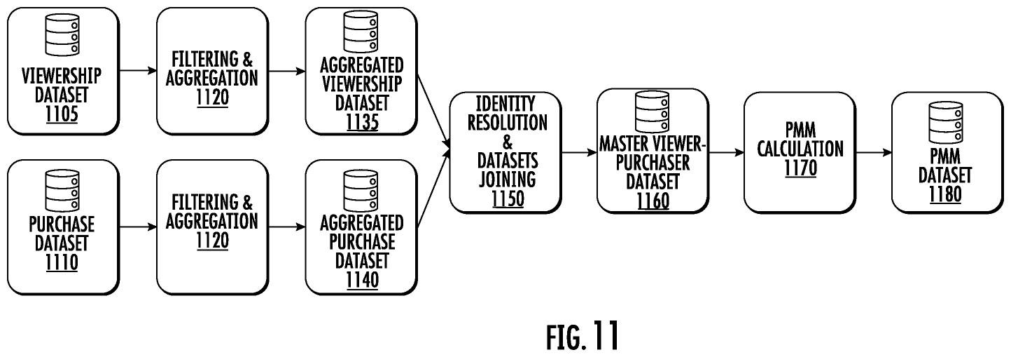

An example illustrating how Media Planning and Insights module 940 executes client's request for PMM scores for a given brand/category and media selection is shown in FIG. 11.

The Media Planning and Insights module 940 receives a client request to calculate one or multiple PPM scores based on given brand/category and media selection detailed in the aggregation specifications accompanying the request. Typical aggregation specifications could include (1) a list of constraints on the transaction record attributes and viewing instance record attributes (where transaction record attributes and viewing instance record attributes are described elsewhere in this application) as well as (2) group-by instructions list.

A typical constraints list could include: (a) time attribute constraints (allowed time ranges of time attributes): (i) allowed time range of transaction times and (ii) allowed time range of media viewing times (the allowed time range of transaction times and allowed time range of media viewing times could be either the same or different), (b) categorical attributes constraints (lists of included and/or excluded categorical attributes): (i) lists of included and/or excluded brands and/or categories and (ii) lists of included and/or excluded networks and/or programs and/or episodes and/or dayparts, and (c) quantitative attributes constraints (allowed ranges of quantitative attributes): (i) allowed range of transaction spend amounts and (ii) allowed range of viewing time lengths;

A typical group-by instructions list contains a list of group-by categorical attributes, the categorical attributes by which transaction records and view instance records should be grouped by.

The Media Planning and Insights module 940 then (a) accesses the Viewership Pannel data storage 937, (b) retrieves a viewership dataset 1105 with the granularity and presence of attributes required to execute aggregations detailed in the received aggregation specifications, and (c) applies the received aggregation specifications 1120 to the retrieved data 1105.

When the retrieved viewership dataset 1105 has individual viewing instance granularity level, the application of the received aggregation specifications 1120 to such dataset 1105 entails (1) selecting a subset of stored viewing instance records with the attributes that meet all constraints from the specifications' list of constraints and (2) then, for each viewing instance aggregation group (defined as a group of selected viewing instance records with the same unique combination of values of (i) viewer ID and (ii) group-by categorical attributes), aggregating the records from the viewing instance aggregation group by (a) summing the values of the quantitative attribute, viewing time length, of all viewing instance records within the viewing instance aggregation group, resulting in new quantitative attribute: total viewing time, and (b) counting the number of viewing instance records across the viewing instance aggregation group, resulting in new quantitative attribute: total viewing instance count (an additional condition requiring counting only viewing instance records with positive values of the viewing time length could be applied to safeguard against counting viewing instance records with non-positive values of viewing time length).

These transformations result in an aggerated viewership set 1135 that contains viewership data aggregated at individual viewer level—with individual viewing-instance-level data being aggregated out.

Each element of the aggerated viewership set 1135 (referred as a viewer record) contains the following attributes: (a) user identifier attributes: viewer ID; (b) timeframes: media viewing timeframe; for all viewer records it has the same value: the allowed time range of media viewing times defined in the aggregation specifications' list of constraints; (c) true categorical attributes: networks, programs, episodes, and dayparts-unless these attributes are not group-by attributes on the grouping instruction list; (d) quantitative attributes and binary (or Boolean) categorical attributes derived from quantitative attributes of the parent media viewership data, such as total viewing time, total viewing instance count, and Is-Program-Viewer (or presence-of-viewer) binary (or Boolean) attribute.

The value of Is-Program-Viewer binary (or Boolean) attribute of a viewer record is determined by the value of the total viewing instance count of the viewer record as follows: Is-Program-Viewer=1 (True), if total viewing instance count value is positive; Is-Program-Viewer=0 (False), otherwise.

The Media Planning and Insights module 940 also (a) accesses the Purchase Pannel data storage 935, (b) retrieves a purchase dataset 1110 with the granularity and presence of attributes required to execute aggregations detailed in the received aggregation specifications, and (c) applies the received aggregation specifications 1120 to the retrieved data 1110.

When the retrieved purchase dataset 1110 has individual transaction granularity level, the application of the received aggregation specifications 1120 to such dataset 1110 entails (1) selecting a subset of transaction records with the attributes that meet all constraints from the specifications' list of constraints and (2) then, for each transaction aggregation group (defined as a group of selected transactions records with the same unique combination of values of (i) purchaser ID and (ii) group-by categorical attributes), aggregating the records from the transaction aggregation group by (a) summing the values of the quantitative attribute, transaction spend amount, of all transaction records within the transaction aggregation group, resulting in new quantitative attribute: total spend amount, and (b) counting the number of transaction records across the transaction aggregation group, resulting in new quantitative attribute: total transaction count (an additional condition requiring counting only transaction records with positive values of the transaction spend amount could be applied to safeguard against counting transactions records with non-positive values of transaction spend, such as product return transaction records);

These transformations result in an aggregated purchase set 1140 that contains purchase data aggregated at individual purchaser level—with individual transaction-level data being aggregated out.

Each element of this aggerated purchase set 1140 (referred as a purchaser record) contains the following attributes: (a) user identifier attributes: purchaser ID; (b) timeframes: transaction timeframe; for all purchaser records it has the same value: the allowed time range of transaction times defined in the aggregation specifications' list of constraints; (c) true categorical attributes: brands and categories-unless these attributes are not group-by attributes on the grouping instruction list; (d) quantitative attributes and binary (or Boolean) categorical attributes derived from quantitative attributes of the parent purchase data, such as total spend amount, total transaction count, and Is-Brand-Purchaser (or presence-of-purchaser) binary (or Boolean) attribute.

The value of Is-Brand-Purchaser binary (or Boolean) attribute of a purchaser record is determined by the value of the total transaction count of the purchaser record as follows: Is-Brand-Purchaser=1 (Truc), if total transaction count value is positive; Is-Brand-Purchaser=0 (False), otherwise.

The two aggregated datasets, aggerated viewership set 1135 and aggerated purchase set 1140, are then passed to the Identity Resolution Module 925 where they are joined 1150 into a master viewer-purchaser dataset 1160.

The resulting master viewer-purchaser dataset 1160 contains viewership data and purchase data aggregated at individual viewer-purchaser level, where a viewer-purchaser is defined as the user (individual person or household) who is either a viewer or a purchaser or both. The resulting master viewer-purchaser dataset 1160 is made of viewer-purchaser records associated with individual viewer-purchasers, where each viewer-purchaser record (1) combines viewer and purchaser records whose viewer and purchaser IDs, respectively, are linked to the viewer-purchaser under consideration and (2) is assigned a unique viewer-purchaser ID.

A unique viewer-purchaser ID could be created via direct concatenation of viewer and purchaser IDs linked to the viewer-purchaser under consideration, or via application of various hashing techniques to a concatenation of viewer and purchaser IDs linked to the viewer-purchaser under consideration, or via applying other standard methodologies;

A viewer-purchaser record of a typical master viewer-purchaser dataset 1160 contains the following attributes: (a) user identifier attributes: unique viewer-purchaser ID; (b) timeframes: (i) media viewing timeframe; for all viewer-purchaser records it has the same value: the allowed time range of media viewing times defined in the aggregation specifications' list of constraints and (ii) transaction timeframe; for all viewer-purchaser records it is the same value: the allowed time ranges of transaction times defined in the aggregation specifications' list of constraints; (c) true categorical attributes inherited from the parent aggregated viewership 1135 and aggregated purchase 1140 sets, that could include (i) networks, programs, episodes, and dayparts, as well as (ii) brands and categories; (d) quantitative attributes and binary (or Boolean) categorical attributes inherited from the parent aggregated viewership 1135 and aggregated purchase 1140 sets, that could include (i) total viewing time, total viewing instance count, and Is-Program-Viewer (or presence-of-viewer) binary (or Boolean) attribute as well as (ii) total spend amount, total transaction count, and Is-Brand-Purchaser (or presence-of-purchaser) binary (or Boolean) attribute.

The newly created master viewer-purchaser dataset 1160 is then stored in the Viewer-Purchaser panel data storage 931.

Using the master viewer-purchaser dataset 1160, the Media Planning and Insights module 940 computes the requested PMM scores 1170 for each combination of true categorical attributes of the master viewer-purchaser dataset 1160.

This results in a PMM dataset 1180, in which all individual viewer-purchasers are aggregated out. Such dataset could be viewed as a collection PMM records, where each PMM record (a) is uniquely identified by Cartesian product of the viewership and purchase dimensions (a unique combination of true categorical attributes of the parent master viewer-purchaser dataset 1160) and (b) contains the values of the requested PMM scores corresponding to the combination of true categorical attributes of the parent master viewer-purchaser dataset 1160 that defines the record.

A PMM record of a typical PMM dataset 1180 contains the following attributes: (a) true categorical attributes inherited from the parent master viewer-purchaser dataset 1160, that could include (i) networks, programs, episodes, and dayparts, as well as (ii) brands and categories; (b) the requested PMM scores evaluated from the quantitative attributes and binary (or Boolean) categorical attributes inherited from the parent master viewer-purchaser dataset 1160 (which could include (i) total viewing time, total viewing instance count, and Is-Program-Viewer (or presence-of-viewer) binary (or Boolean) attribute as well as (ii) total spend amount, total transaction count, and Is-Brand-Purchaser (or presence-of-purchaser) binary (or Boolean) attribute); (c) timeframes: (i) media viewing timeframe; for all viewer-purchaser records it has the same value: the allowed time range of media viewing times defined in the aggregation specifications' list of constraints and (ii) transaction timeframe; for all viewer-purchaser records it is the same value: the allowed time ranges of transaction times defined in the aggregation specifications' list of constraints.

The resulting PMM dataset 1180 is stored in the Viewer-Purchaser panel data storage 931 and sends them back to the client.

The Campaign Measurements module 960 leverages the Viewer-Purchaser-Campaign panel 933 to build and update advertising campaign performance metrics. These metrics measure the success of an advertising campaign by attributing transactions (purchases of the brand promoted by the campaign) to preceding exposures to the campaign's ads. The module could support various types of attribution models and rules specified by lookback windows from the moment of the transaction, ad viewing time, number and sequence of exposures, and others. The module could also support casual (incremental) metrics, such as sales lift and incremental purchases, specified as the differences between the value of the metric (e.g., consumer spend or number of transactions) calculated for the audience exposed to campaign ads and the value of the same metrics calculated for the audience not exposed to campaign ads. The model recalculates the performance metrics as the campaign is being executed. Updated metrics are reported to the advertiser/agency. The advertiser could access the updated metrics either via UI or via API. The metrics are also fed into the Campaign Optimization module 970 to be used for campaign optimization.

The Campaign Optimization module 970 leverages the Viewer-Purchaser-Campaign panel 933 and the campaign performance metrics generated by the campaign measurement module 960 to optimize advertisement campaign in-flight. Based on the changes of the performance metrics, the module could reallocate the campaign budget from underperforming to overperforming media/cohorts as the campaign progresses. The module could (i) provide recommendations to the advertiser/agencies or, (ii) when integrated with campaign execution platforms (e.g., DSPs) via APIs, directly adjust campaign budget caps, bid prices, and other ad-spend-affecting settings in the campaign execution platform.

In one implementation, as the advertising campaign progresses, the Campaign Optimization module 970 constantly decides what percentage of budget (impressions) to allocate to each media/cohort to maximize earning while continuously learning. With limited campaign budget, the Module solves resource allocation problem on ongoing bases, finding the balance between exploiting the data it already has about user advertising engagements and further exploring those engagements to reduce their results' predictions uncertainty and increase their effectiveness. On the one hand, the module continuously shifts more budget towards the better performing media/cohorts, exploiting its current knowledge about the campaign's performance. On the other hand, the module always reserves part of the budget to test other media/cohorts, exploring to improve its knowledge about the campaign's performance. The module does it by using multi-armed bandit methods, a subclass of reinforcement learning algorithms, such as Thompson Sampling (randomized probability matching), e-greedy, or Upper-Confidence-Bound (UCB).

In addition, by leveraging supervised learning algorithms, such as deep neural networks, gradient boosting, or other decision tree methods, to learn accurate and detailed media engagement result prediction models, the Campaign Optimization module 970 delivers a highly efficient media-specific targeting. In particular, the module enables successful campaign optimization across large, varied, and high-dimensional sets of media features, by constructing and constantly updating dynamic performance-maximizing maps between media/cohorts, on the one hand, and the advertised categories and brands, on the other hand (along the lines of contextual multi-armed bandit approach) As the module continuously learns which media/cohorts features are important for which advertisement category/brand, it further improves campaign performance by enabling increasingly more tailored engagements. The following are examples of various implementations.

1. A method comprising:
receiving purchase data at individual transaction level of granularity as a set of individual transaction's attributes, often referred to as a transaction record;
wherein each transaction record contains at least the following attributes: (a) user identifier attributes: purchaser identifier, (b) time attributes: transaction timestamp, (c) categorical attributes: brand identifier and/or category identifier, and (d) quantitative attributes: at least transaction spend amount;
storing received purchase data at a storage server;
receiving media viewership data at individual viewing instance level of granularity as a set of individual viewing instance's attributes, often referred to as a viewing instance record;
wherein each viewing instance record contains at least the following attributes: (a) user identifier attributes: viewer identifier, (b) time attributes: viewing start timestamp and/or viewing end timestamp, (c) categorical attributes: network identifier and/or program identifier and/or episode identifier and/or day part identifier, and (d) quantitative attributes: viewing time length;
storing received media viewership data at a storage server;
receiving aggregation specifications that include (1) a list of constraints on the transaction record attributes and viewing instance record attributes as well as (2) group-by instructions list;
wherein a typical constraints list could include: (a) time attribute constraints (allowed time ranges of time attributes): (i) allowed time range of transaction times and (ii) allowed time range of media viewing times (the allowed time range of transaction times and allowed time range of media viewing times could be either the same or different), (b) categorical attributes constraints (lists of included and/or excluded categorical attributes): (i) lists of included and/or excluded brand identifiers and/or category identifiers and (ii) lists of included and/or excluded network identifiers and/or program identifiers and/or episode identifiers and/or day part identifiers, and (c) quantitative attributes constraints (allowed ranges of quantitative attributes): (i) allowed range of transaction spend amounts and (ii) allowed range of viewing time lengths;
wherein a typical group-by instructions list contains a list of group-by categorical attributes, the categorical attributes by which transaction records and view instance records should be grouped by;
using at least one processor, applying received aggregation specifications to stored purchase data that entails (1) selecting a subset of stored transaction records with the attributes that meet all constraints from the specifications' list of constraints and (2) then, for each transaction aggregation group (defined as a group of selected transactions records with the same unique combination of values of (i) purchaser identifier and (ii) group-by categorical attributes), aggregating the records from the transaction aggregation group by (a) summing the values of the quantitative attribute, transaction spend amount, of all transaction records within the transaction aggregation group, resulting in new quantitative attribute: total spend amount, and (b) counting the number of transaction records across the transaction aggregation group, resulting in new quantitative attribute: total transaction count (an additional condition requiring counting only transaction records with positive values of the transaction spend amount could be applied to safeguard against counting transactions records with non-positive values of transaction spend, such as product return transaction records);
wherein application of aggregation specifications to stored purchase data results in aggerated purchase set that contains purchase data aggregated at individual purchaser level—with individual transaction-level data being aggregated out;
wherein each element of the aggerated purchase set (often referred to as a purchaser record) contains the following attributes: (a) user identifier attributes: purchaser identifier; (b) timeframes: transaction timeframe; for all purchaser records it has the same value: the allowed time range of transaction times defined in the aggregation specifications' list of constraints; (c) true categorical attributes: brand identifier and category identifier-unless these attributes are not group-by attributes on the grouping instruction list; (d) quantitative attributes and binary (or Boolean) categorical attributes derived from quantitative attributes of the parent purchase data, such as total spend amount, total transaction count, and Is-Brand-Purchaser (or presence-of-purchaser) binary (or Boolean) attribute;
wherein the value of Is-Brand-Purchaser binary (or Boolean) attribute of a purchaser record is determined by the value of the total transaction count of the purchaser record as follows: Is-Brand-Purchaser=1 (True), if total transaction count value is positive; Is-Brand-Purchaser=0 (False), otherwise;
using at least one processor, applying received aggregation specifications to stored media viewership data that entails (1) selecting a subset of stored viewing instance records with the attributes that meet all constraints from the specifications' list of constraints and (2) then, for each viewing instance aggregation group (defined as a group of selected viewing instance records with the same unique combination of values of (i) viewer identifier and (ii) group-by categorical attributes), aggregating the records from the viewing instance aggregation group by (a) summing the values of the quantitative attribute, viewing time length, of all viewing instance records within the viewing instance aggregation group, resulting in new quantitative attribute: total viewing time, and (b) counting the number of viewing instance records across the viewing instance aggregation group, resulting in new quantitative attribute: total viewing instance count (an additional condition requiring counting only viewing instance records with positive values of the viewing time length could be applied to safeguard against counting viewing instance records with non-positive values of viewing time length);
wherein application of aggregation specifications to stored media viewership data results in aggerated media viewership set that contains media viewership data aggregated at individual viewer level—with individual viewing-instance-level data being aggregated out;
wherein each element of the aggerated media viewership set (often referred to as a viewer record) contains the following attributes: (a) user identifier attributes: viewer identifier; (b) timeframes: media viewing timeframe; for all viewer records it has the same value: the allowed time range of media viewing times defined in the aggregation specifications' list of constraints; (c) true categorical attributes: network identifier, program identifier, episode identifier, and day part identifier-unless these attributes are not group-by attributes on the grouping instruction list; (d) quantitative attributes and binary (or Boolean) categorical attributes derived from quantitative attributes of the parent media viewership data, such as total viewing time, total viewing instance count, and Is-Program-Viewer (or presence-of-viewer) binary (or Boolean) attribute;
wherein the value of Is-Program-Viewer binary (or Boolean) attribute of a viewer record is determined by the value of the total viewing instance count of the viewer record as follows: Is-Program-Viewer=1 (True), if total viewing instance count value is positive; Is-Program-Viewer=0 (False), otherwise;
using at least one processor, joining the two aggregated datasets, aggerated media viewership set and aggerated purchase set, into a master viewer-purchaser dataset by leveraging viewer-purchaser mappings that link together purchaser and viewer identifiers associated with the same user;
wherein typical viewer-purchaser mapping is a collection of viewer-purchaser identity groups, where each such group contains one or multiple viewer identifiers and one or multiple purchaser identifiers, all of these identifiers being linked to the same user (or, for some viewer-purchaser mappings, the same group of users); for some viewer-purchaser mappings, all their viewer-purchaser identity groups contain one and only one viewer identifier and one and only one purchaser identifier; for other viewer-purchaser mappings, some or all of their viewer-purchaser identity groups contain multiple viewer identifiers and/or multiple purchaser identifiers;
wherein each viewer-purchaser identity group is associated with a unique viewer-purchaser identifier;
wherein the set of viewer-purchaser identifiers of the master viewer-purchaser dataset—which was created by joining its two parent aggregated datasets, aggerated media viewership set and aggerated purchase set—is the set of all viewer-purchaser identifiers linking the following two user identifier sets, (i) the set of viewer identifiers of the parent aggregated media viewership set and (ii) the set of purchaser identifiers of the parent aggregated purchase set;
wherein master viewer-purchaser dataset contains media viewership data and purchase data aggregated at individual viewer-purchaser identifier level; each element of the master viewer-purchaser dataset (often referred to as viewer-purchaser record) contains the following attributes: (a) user identifier attributes: unique viewer-purchaser identifier; (b) timeframes: (i) media viewing timeframe; for all viewer-purchaser records it has the same value: the allowed time range of media viewing times defined in the aggregation specifications' list of constraints and (ii) transaction timeframe; for all viewer-purchaser records it is the same value: the allowed time ranges of transaction times defined in the aggregation specifications' list of constraints; (c) true categorical attributes inherited from the parent aggregated media viewership and aggregated purchase sets, that could include (i) network identifier, program identifier, episode identifier, and day part identifier as well as (ii) brand identifier and category identifier; (d) quantitative attributes and binary (or Boolcan) categorical attributes inherited from the parent aggregated media viewership and aggregated purchase sets, that could include (i) total viewing time, total viewing instance count, and Is-Program-Viewer (or presence-of-viewer) binary (or Boolean) attribute as well as (ii) total spend amount, total transaction count, and Is-Brand-Purchaser (or presence-of-purchaser) binary (or Boolean) attribute;
storing newly created master viewer-purchaser dataset at a storage server;
using at least one processor and the master viewer-purchaser dataset, calculating Purchase Media Metrics, PMMs, that show (i) presence of brand purchasers, level of brand spend, number of brand transactions, and other brand purchase behavior characteristics (for a specific combination of one or multiple brands and/or categories controlled by aggregation specifications) (1) across media viewing audience and (2) across media non-viewers (for a specific combination of one or multiple networks and/or programs and/or episodes and/or dayparts controlled by aggregation specifications) as well as (ii) presence of media viewers, media viewing time, number of media viewing instances, and other media viewing behavior characteristics (for a specific combination of one or multiple networks and/or programs and/or episodes and/or dayparts controlled by aggregation specifications) (1) across brand purchasers and (2) across brand non-purchasers (for a specific combination of one or multiple brands and/or categories controlled by aggregation specifications);
wherein PMMs are calculated for each combination of true categorical attributes of the master viewer-purchaser dataset, resulting in creation of a PMM dataset, in which all individual viewer-purchaser identifiers are aggregated out;
wherein such PMM dataset could be viewed as a collection PMM records, where each PMM record (a) is uniquely identified by a unique combination of true categorical attributes of the parent master viewer-purchaser dataset and (b) contains the values of PMMs corresponding to the combination of true categorical attributes of the parent master viewer-purchaser dataset that defines the record;
a PMM record of a typical PMM dataset contains the following attributes: (a) truc categorical attributes inherited from the parent master viewer-purchaser dataset, that could include (i) network identifier, program identifier, episode identifier, and day part identifier, as well as (ii) brand identifier and category identifier; (b) PMMs evaluated from the quantitative attributes and binary (or Boolean) categorical attributes inherited from the parent master viewer-purchaser dataset (which could include (i) total viewing time, total viewing instance count, and Is-Program-Viewer (or presence-of-viewer) binary (or Boolean) attribute as well as (ii) total spend amount, total transaction count, and Is-Brand-Purchaser (or presence-of-purchaser) binary (or Boolean) attribute); (c) timeframes: (i) media viewing timeframe; for all viewer-purchaser records it has the same value: the allowed time range of media viewing times defined in the aggregation specifications' list of constraints and (ii) transaction timeframe; for all viewer-purchaser records it is the same value: the allowed time ranges of transaction times defined in the aggregation specifications' list of constraints; and
storing newly created PMM dataset at a storage server.

2. The method of claim 1 wherein the PMMs could be of different types, with the following factors and their combinations defining different PMM types: (a) input variables used in PMM construction: such as (i) transaction spend amount, total (aggregated) spend amount, total (aggregated) number of transactions, presence of purchasers, total (aggregated) number of purchasers (ii) media viewing instance time length, total (aggregated) media viewing time, total (aggregated) number of media viewing instances, presence of media viewers, total (aggregated) number of media viewers (the size of the media viewing audience); (b) expressions used in PMM construction: e.g., counts, sums, percentages, ratios, indices, geospatial averages, time averages, as well as weighted averages and totals (weighted by viewing time, spend amount, decay factors, and others); (c) overlayed constraints: audiences (demographics, behaviors, lists of IDs, and others), geography (e.g., Country, State/Province, DMA, and others), time (Part of Day, Day of Week, windows, and others); (d) transformation and normalization: e.g., balancing to match specific audience composition (e.g., projection onto national or specific geographical level, such as state or province), pre-aggregations (e.g., at household level).

3. The method of claim 2 wherein the PMMs include percentage and ratio metrics defined, for given media (a specific combination of one or multiple networks and/or programs and/or episodes and/or dayparts controlled by aggregation specifications) and brand (a specific combination of one or multiple brands and/or categories controlled by aggregation specifications), as follows: (i) purchase behavior metrics: (1) viewer metrics: (a) purchaser percentage among viewers: [Total number of purchasers of the brand under consideration among all viewers of the media under consideration] divided by [Total number of viewers of the media under consideration], (b) average spend per viewer: [Total spend on the brand under consideration among all viewers of the media under consideration] divided by [Total number of viewers of the media under consideration], (c) average number of transactions per viewer: [Total number of transactions of the brand under consideration among all viewers of the media under consideration] divided by [Total number of viewers of the media under consideration], (d) average basket size of a viewer: [average spend per viewer] divided by [average number of transactions per viewer]; (2) non-viewer metrics: the same as the viewer metrics (a)-(d) of (i)(1) above where viewer is replaced by non-viewer (defined as a viewer-purchaser identifiers with Is-Program-Viewer attribute equal to 0 (or false)); (ii) media viewing behavior metrics: (1) purchaser metrics: (a) viewer percentage among purchasers: [Total number of viewers of the media under consideration among all purchasers of the brand under consideration] divided by [Total number of purchasers of the brand under consideration], (b) average media viewing time per purchaser: [Total viewing time of the media under consideration among all purchasers of the brand under consideration] divided by [Total number of purchasers of the brand under consideration], (c) average number of viewing instances per purchaser: [Total number of viewing instances of the media under consideration among all purchasers of the brand under consideration] divided by [Total number of purchasers of the brand under consideration], (d) average length of the viewing time per viewing instance of a purchaser: [average media viewing time per purchaser] divided by [average number of viewing instances per purchaser]; (2) non-purchaser metrics: the same as the purchaser metrics (a)-(d) of (ii)(1) above where purchaser is replaced by non-purchaser (defined as a viewer-purchaser identifiers with Is-Brand-Purchaser attribute equal to 0 (or false)).

4. The method of claim 3 wherein the PMMs include index metrics that are constructed, for given media (a specific combination of one or multiple networks and/or programs and/or episodes and/or dayparts controlled by aggregation specifications) and brand (a specific combination of one or multiple brands and/or categories controlled by aggregation specifications), from percentage and ratio metrics described in claim 3 by dividing percentage and ratio metrics evaluated for the brand and media under consideration by the same percentage and ratio metrics but evaluated for the index's base audiences;
wherein (i) for indexes constructed from viewer/non-viewer metrics (such as purchaser percentage among viewers/non-viewers, average spend per viewer/non-viewer, average number of transactions per viewer/non-viewer, and average basket size of a viewer/non-viewer), viewer/non-viewer base audiences (usually viewers/non-viewers of a broader set of media than the media under consideration) are used as the indexes' base audiences and
wherein (ii) for indexes constructed from purchaser/non-purchaser metrics (such as viewer percentage among purchasers/non-purchasers, average media viewing time per purchaser/non-purchaser, average number of viewing instances per purchaser/non-purchaser, and average length of the viewing time per viewing instance of a purchaser/non-purchaser), purchaser/non-purchaser base audiences (usually purchasers/non-purchasers of a broader set of brands than the brand under consideration) are used as indexes' base audiences.

5. The method of claim 1 wherein various constraints could be applied to PMMs, such as (i) minimal number of transactions threshold and/or minimal spend amount threshold required for purchaser qualification, and/or (ii) minimal number of viewing instances threshold and/or minimal viewing time length threshold required for media viewer qualification.

6. The method of claim 2 wherein weights could be used in definitions of percentage, ratio, and index PMM metrics. The following weight applying methods could be used in constructing PMMs—for given media (a specific combination of one or multiple networks and/or programs and/or episodes and/or dayparts controlled by aggregation specifications) and brand (a specific combination of one or multiple brands and/or categories controlled by aggregation specifications): (i) the total viewing time of the media under consideration spent by the media viewer could be used as a weighting factor on the viewer's purchase behavior with respect to the brand under consideration and thus, be deployed in viewer metrics' construction; (ii) the total amount spent on the brand under consideration by the brand purchaser could be used as a weighting factor on the purchaser's media viewing behavior with respect to the media under consideration and thus, be deployed in purchaser metrics' construction.

7. The method of claim 6 wherein the following viewing-time weighted viewer metrics are used: (a) purchaser percentage among viewers (viewing-time weighted): sum[product[(Is-Brand-Purchaser (of the brand under consideration), total viewing time (of the media under consideration)], across all viewers of the media under consideration] divided by sum[total viewing time (of the media under consideration), across all viewers of the media under consideration]; (b) average spend per viewer (viewing-time weighted): sum[product[total spend amount (on the brand under consideration), total viewing time (of the media under consideration)], across all viewers of the media under consideration] divided by sum [total viewing time (of the media under consideration), across all viewers of the media under consideration]; (c) average number of transactions per viewer (viewing-time weighted): sum[product[total transaction count (of the brand under consideration), total viewing time (of the media under consideration)], across all viewers of the media under consideration] divided by sum [total viewing time (of the media under consideration), across all viewers of the media under consideration]; (d) average basket size of a viewer (spend-amount weighted): [average spend per viewer (viewing-time weighted)] divided by [average number of transactions per viewer (viewing-time weighted)].

8. The method of claim 6 wherein the following spend-amount weighted purchaser metrics are used: (a) viewer percentage among purchasers (spend-amount weighted): sum[product[(Is-Program-Viewer (of the media under consideration), total spend amount (on the brand under consideration)], across all purchasers of the brand under consideration] divided by sum[total spend amount (on the brand under consideration), across all purchasers of the brand under consideration]; (b) average media viewing time per purchaser (spend-amount weighted): sum[product[total viewing time (of the media under consideration), total spend amount (on the brand under consideration)], across all purchasers of the brand under consideration] divided by sum[total spend amount (on the brand under consideration), across all purchasers of the brand under consideration]; (c) average number of viewing instances per purchaser (spend-amount weighted): sum[product[total viewing instance count (of the media under consideration), total spend amount (on the brand under consideration)], across all purchasers of the brand under consideration] divided by sum[total spend amount (on the brand under consideration), across all purchasers of the brand under consideration]; (d) average length of the viewing time per viewing instance of a purchaser (spend-amount weighted): [average media viewing time per purchaser (spend-amount weighted)] divided by [average number of viewing instances per purchaser (spend-amount weighted)].

9. The method of claim 2 wherein, as part of data normalization, the datasets used in PMM construction could are balanced against different target populations (ground truth), such as census, for example for the entire United States, or other data sets of general population or of the viewership of specific media, constrained to specific geographic regions, and others.

10. The method of claim 2 wherein, wherein the balancing is performed (i) against various balancing factors, such as geography (e.g., state/province, DMA), demographics (e.g., age, gender, education level, household income), and others and (ii) at different balancing levels (e.g., Individual or Household).

11. The method of claim 1 wherein the source of purchase data is debit and credit card transactions and purchaser identifier is a debit and credit card identifier.

12. The method of claim 1 wherein the source of media viewership data is automatic content recognition (ACR), software development kits (SDK), and server logs generated data.

13. The method of claim 1 wherein, instead of transaction timestamp, transaction date or other time identifier is used as the time attribute of transaction records.

14. The method of claim 1 wherein viewing time length is not an attribute of viewing instance records but both viewing start timestamp and viewing end timestamp are attributes of viewing instance records so that the viewing time length has to be calculated as the difference between the viewing end timestamp and viewing start timestamp.

15. The method of claim 1 wherein all or some of the following data sets are stored at storage server(s): the aggregation specifications, aggerated purchase set, and aggerated media viewership set.

16. The method of claim 1 wherein it enables analyzing consumer behavior based on information that is directly linked to consumer purchases, the ultimate business outcomes sought after by both, buy-side media market participants, such as advertisers, marketers, and agencies, and sell-side media market participants, such as publishers, publisher networks, and sell-side aggregators, and is used by both sides of media market participants during media planning stage: (a) by buy-side media market participants, to facilitate advertising campaign planning and media selection process buy-side media market participants and (b) by sell-side media market participants, to support their ad inventory sales effort and defend their media inventory prices.

17. The method of claim 1 wherein, along with third party advertising inventory availability and cost data, it is used for pre-campaign optimization.

18. The method of claim 1 wherein disparate media networks or programs or episodes or dayparts could be aggregated into a bundle by selecting a specific combination of one or multiple networks and/or programs and/or episodes and/or dayparts, wherein PMMs could be calculated for the bundle under consideration;

19. The method of claim 1 wherein disparate brands/categories could be aggregated into a brand group by selecting a specific combination of one or multiple brands and/or categories, wherein PMMs could be calculated for the brand group under consideration.

20. The method of claim 1 wherein the viewer-purchaser mappings could be implemented as crosswalk tables based on common keys (such as common IP addresses, email addresses, or hashed email addresses (HEMs) associated with purchaser identifiers and viewer identifiers) or through a third-party identity resolution services,
wherein unique viewer-purchaser identifiers for viewer-purchaser identity groups are created via direct concatenation of all viewer identifiers and purchaser identifiers of the group, or via application of various hashing techniques to a concatenation of all viewer identifiers and purchaser identifiers of the group, or via applying other standard methodologies.

21. The method of claim 1 wherein user, user identifier, purchaser, purchaser identifier, viewer, viewer identifier could refer to both individual person and household.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
receiving purchase data at individual transaction level of granularity as a set of individual transaction's attributes, which can be referred to as a transaction record;
wherein each transaction record contains at least the following attributes: (a) user identifier attributes, (b) time attributes, (c) categorical attributes, and (d) quantitative attributes;
storing received purchase data at a storage server;
receiving media viewership data at individual viewing instance level of granularity as a set of individual viewing instance's attributes, which can be referred to as a viewing instance record;
wherein each viewing instance record contains at least the following attributes: (a) user identifier attributes, (b) time attributes, (c) categorical attributes, and (d) quantitative attributes;
storing received media viewership data at a storage server;
receiving aggregation specifications that include (1) a list of constraints on the transaction record attributes and viewing instance record attributes and (2) group-by instructions list;
wherein a constraints list includes: (a) time attribute constraints, (b) categorical attributes constraints, and (c) quantitative attributes constraints;
wherein a group-by instructions list comprises a list of group-by categorical attributes, the categorical attributes by which transaction records and view instance records should be grouped by;
using at least one processor, applying received aggregation specifications to stored purchase data that comprises (1) selecting a subset of stored transaction records with the attributes that meet all constraints from the specifications' list of constraints and (2) for each transaction aggregation group, aggregating records from the transaction aggregation group;
wherein application of aggregation specifications to stored purchase data results in a aggerated purchase set that contains purchase data aggregated at individual purchaser level with individual transaction-level data being aggregated out;
wherein each element of the aggerated purchase set (which can be referred to as a purchaser record) contains the following attributes: (a) user identifier attributes; (b) timeframes; (c) true categorical attributes; (d) quantitative attributes and binary (or Boolean) categorical attributes derived from quantitative attributes of the parent purchase data;
wherein the value of Is-Brand-Purchaser binary (or Boolean) attribute of a purchaser record is determined by the value of the total transaction count of the purchaser record as follows: Is-Brand-Purchaser=1 (True), if total transaction count value is positive; Is-Brand-Purchaser=0 (False), otherwise;
using at least one processor, applying received aggregation specifications to stored media viewership data that comprises (1) selecting a subset of stored viewing instance records with the attributes that meet all constraints from the specifications' list of constraints and (2) for each viewing instance aggregation group, aggregating the records from the viewing instance aggregation group;
wherein application of aggregation specifications to stored media viewership data results in aggerated media viewership set that contains media viewership data aggregated at individual viewer level with individual viewing-instance-level data being aggregated out;
wherein each element of the aggerated media viewership set (which can be referred to as a viewer record) includes the following attributes: (a) user identifier attributes; (b) timeframes; (c) true categorical attributes; (d) quantitative attributes and binary (or Boolean) categorical attributes derived from quantitative attributes of the parent media viewership data;
wherein the value of Is-Program-Viewer binary (or Boolean) attribute of a viewer record is determined by the value of the total viewing instance count of the viewer record as follows: Is-Program-Viewer=1 (True), if total viewing instance count value is positive; Is-Program-Viewer=0 (False), otherwise;
using at least one processor, joining the two aggregated datasets, aggerated media viewership set and aggerated purchase set, into a master viewer-purchaser dataset by leveraging viewer-purchaser mappings that link together purchaser and viewer identifiers associated with the same user;
wherein typical viewer-purchaser mapping is a collection of viewer-purchaser identity groups, where each such group contains one or multiple viewer identifiers and one or multiple purchaser identifiers, all of these identifiers being linked to the same user (or, for some viewer-purchaser mappings, the same group of users); for some viewer-purchaser mappings, all their viewer-purchaser identity groups contain one and only one viewer identifier and one and only one purchaser identifier; for other viewer-purchaser mappings, some or all of their viewer-purchaser identity groups contain multiple viewer identifiers and/or multiple purchaser identifiers;
wherein each viewer-purchaser identity group is associated with a unique viewer-purchaser identifier;
wherein the set of viewer-purchaser identifiers of the master viewer-purchaser dataset, which was created by joining its two parent aggregated datasets, aggerated media viewership set and aggerated purchase set, is the set of all viewer-purchaser identifiers linking the following two user identifier sets, (i) the set of viewer identifiers of the parent aggregated media viewership set and (ii) the set of purchaser identifiers of the parent aggregated purchase set;
wherein master viewer-purchaser dataset contains media viewership data and purchase data aggregated at individual viewer-purchaser identifier level;
storing newly created master viewer-purchaser dataset at a storage server;
using at least one processor and the master viewer-purchaser dataset, calculating Purchase Media Metrics, PMMs, that show (i) presence of brand purchasers, level of brand spend, number of brand transactions, and other brand purchase behavior characteristics (1) across media viewing audience and (2) across media non-viewers (for a specific combination of one or multiple networks and/or programs and/or episodes and/or dayparts controlled by aggregation specifications) as well as (ii) presence of media viewers, media viewing time, number of media viewing instances, and other media viewing behavior characteristics (for a specific combination of one or multiple networks and/or programs and/or episodes and/or dayparts controlled by aggregation specifications);
wherein PMMs are calculated for each combination of true categorical attributes of the master viewer-purchaser dataset, resulting in creation of a PMM dataset, in which all individual viewer-purchaser identifiers are aggregated out;
wherein such PMM dataset could be viewed as a collection PMM records, where each PMM record (a) is uniquely identified by a unique combination of true categorical attributes of the parent master viewer-purchaser dataset and (b) contains the values of PMMs corresponding to the combination of true categorical attributes of the parent master viewer-purchaser dataset that defines the record;
a PMM record of a PMM dataset contains the following attributes: (a) true categorical attributes inherited from the parent master viewer-purchaser dataset; (b) PMMs evaluated from the quantitative attributes and binary (or Boolean) categorical attributes; and (c) timeframes; and
storing newly created PMM dataset at a storage server.

2. The method of claim 1 wherein the PMMs could be of different types, with the following factors and their combinations defining different PMM types: (a) input variables used in PMM construction: such as (i) transaction spend amount, total (aggregated) spend amount, total (aggregated) number of transactions, presence of purchasers, total (aggregated) number of purchasers (ii) media viewing instance time length, total (aggregated) media viewing time, total (aggregated) number of media viewing instances, presence of media viewers, total (aggregated) number of media viewers (the size of the media viewing audience); (b) expressions used in PMM construction: e.g., counts, sums, percentages, ratios, indices, geospatial averages, time averages, as well as weighted averages and totals (weighted by viewing time, spend amount, decay factors, and others); (c) overlayed constraints: audiences (demographics, behaviors, lists of IDs, and others), geography (e.g., Country, State/Province, DMA, and others), time (Part of Day, Day of Week, windows, and others); (d) transformation and normalization: e.g., balancing to match specific audience composition (e.g., projection onto national or specific geographical level, such as state or province), pre-aggregations (e.g., at household level).

3. The method of claim 2 wherein the PMMs include percentage and ratio metrics defined, for given media (a specific combination of one or multiple networks and/or programs and/or episodes and/or dayparts controlled by aggregation specifications) and brand (a specific combination of one or multiple brands and/or categories controlled by aggregation specifications), as follows: (i) purchase behavior metrics and (ii) media viewing behavior metrics comprising
purchaser metrics: (a) viewer percentage among purchasers: [Total number of viewers of the media under consideration among all purchasers of the brand under consideration] divided by [Total number of purchasers of the brand under consideration], (b) average media viewing time per purchaser: [Total viewing time of the media under consideration among all purchasers of the brand under consideration] divided by [Total number of purchasers of the brand under consideration], (c) average number of viewing instances per purchaser: [Total number of viewing instances of the media under consideration among all purchasers of the brand under consideration] divided by [Total number of purchasers of the brand under consideration], (d) average length of the viewing time per viewing instance of a purchaser: [average media viewing time per purchaser] divided by [average number of viewing instances per purchaser.

4. The method of claim 3 wherein the PMMs include index metrics that are constructed, for given media (a specific combination of one or multiple networks and/or programs and/or episodes and/or dayparts controlled by aggregation specifications) and brand (a specific combination of one or multiple brands and/or categories controlled by aggregation specifications), from the percentage metrics and ratio metrics by dividing percentage and ratio metrics evaluated for the brand and media under consideration by the same percentage and ratio metrics but evaluated for the index's base audiences;
wherein (i) for indexes constructed from viewer/non-viewer metrics (such as purchaser percentage among viewers/non-viewers, average spend per viewer/non-viewer, average number of transactions per viewer/non-viewer, and average basket size of a viewer/non-viewer), viewer/non-viewer base audiences (usually viewers/non-viewers of a broader set of media than the media under consideration) are used as the indexes' base audiences and
wherein (ii) for indexes constructed from purchaser/non-purchaser metrics (such as viewer percentage among purchasers/non-purchasers, average media viewing time per purchaser/non-purchaser, average number of viewing instances per purchaser/non-purchaser, and average length of the viewing time per viewing instance of a purchaser/non-purchaser), purchaser/non-purchaser base audiences (usually purchasers/non-purchasers of a broader set of brands than the brand under consideration) are used as indexes' base audiences.

5. The method of claim 1 wherein various constraints could be applied to PMMs, such as (i) minimal number of transactions threshold and/or minimal spend amount threshold required for purchaser qualification, and/or (ii) minimal number of viewing instances threshold and/or minimal viewing time length threshold required for media viewer qualification.

6. The method of claim 2 wherein weights could be used in definitions of percentage, ratio, and index PMM metrics.

7. The method of claim 6 wherein the following viewing-time weighted viewer metrics are used: (a) purchaser percentage among viewers (viewing-time weighted): sum[product[(Is-Brand-Purchaser (of the brand under consideration), total viewing time (of the media under consideration)], across all viewers of the media under consideration] divided by sum[total viewing time (of the media under consideration), across all viewers of the media under consideration]; (b) average spend per viewer (viewing-time weighted): sum[product[total spend amount (on the brand under consideration), total viewing time (of the media under consideration)], across all viewers of the media under consideration] divided by sum [total viewing time (of the media under consideration), across all viewers of the media under consideration]; (c) average number of transactions per viewer (viewing-time weighted): sum[product[total transaction count (of the brand under consideration), total viewing time (of the media under consideration)], across all viewers of the media under consideration] divided by sum [total viewing time (of the media under consideration), across all viewers of the media under consideration]; (d) average basket size of a viewer (spend-amount weighted): [average spend per viewer (viewing-time weighted)] divided by [average number of transactions per viewer (viewing-time weighted)].

8. The method of claim 6 wherein the following spend-amount weighted purchaser metrics are used: (a) viewer percentage among purchasers (spend-amount weighted): sum[product[(Is-Program-Viewer (of the media under consideration), total spend amount (on the brand under consideration)], across all purchasers of the brand under consideration] divided by sum[total spend amount (on the brand under consideration), across all purchasers of the brand under consideration]; (b) average media viewing time per purchaser (spend-amount weighted): sum[product[total viewing time (of the media under consideration), total spend amount (on the brand under consideration)], across all purchasers of the brand under consideration] divided by sum[total spend amount (on the brand under consideration), across all purchasers of the brand under consideration]; (c) average number of viewing instances per purchaser (spend-amount weighted): sum[product[total viewing instance count (of the media under consideration), total spend amount (on the brand under consideration)], across all purchasers of the brand under consideration] divided by sum[total spend amount (on the brand under consideration), across all purchasers of the brand under consideration]; (d) average length of the viewing time per viewing instance of a purchaser (spend-amount weighted): [average media viewing time per purchaser (spend-amount weighted)] divided by [average number of viewing instances per purchaser (spend-amount weighted)].

9. The method of claim 2 wherein, as part of data normalization, the datasets used in PMM construction could are balanced against different target populations (ground truth), such as census, for example for the entire United States, or other data sets of general population or of the viewership of specific media, constrained to specific geographic regions, and others.

10. The method of claim 2 wherein, wherein the balancing is performed (i) against various balancing factors, such as geography (e.g., state/province, DMA), demographics (e.g., age, gender, education level, household income), and others and (ii) at different balancing levels (e.g., Individual or Household).

11. The method of claim 1 wherein the source of purchase data is debit and credit card transactions and purchaser identifier is a debit and credit card identifier.

12. The method of claim 1 wherein the source of media viewership data is automatic content recognition (ACR), software development kits (SDK), and server logs generated data.

13. The method of claim 1 wherein, instead of transaction timestamp, transaction date or other time identifier is used as the time attribute of transaction records.

14. The method of claim 1 wherein viewing time length is not an attribute of viewing instance records but both viewing start timestamp and viewing end timestamp are attributes of viewing instance records so that the viewing time length has to be calculated as the difference between the viewing end timestamp and viewing start timestamp.

15. The method of claim 1 wherein all or some of the following data sets are stored at storage server(s): the aggregation specifications, aggerated purchase set, and aggerated media viewership set.

16. The method of claim 1 wherein it enables analyzing consumer behavior based on information that is directly linked to consumer purchases, the ultimate business outcomes sought after by both, buy-side media market participants, such as advertisers, marketers, and agencies, and sell-side media market participants, such as publishers, publisher networks, and sell-side aggregators, and is used by both sides of media market participants during media planning stage: (a) by buy-side media market participants, to facilitate advertising campaign planning and media selection process buy-side media market participants and (b) by sell-side media market participants, to support their ad inventory sales effort and defend their media inventory prices.

17. The method of claim 1 wherein, along with third party advertising inventory availability and cost data, it is used for pre-campaign optimization, or
user, user identifier, purchaser, purchaser identifier, viewer, viewer identifier could refer to both individual person and household.

18. The method of claim 1 wherein disparate media networks/programs/episodes/dayparts could be aggregated into a bundle by selecting a specific combination of one or multiple networks and/or programs and/or episodes and/or dayparts, wherein PMMs could be calculated for the bundle under consideration.

19. The method of claim 1 wherein disparate brands/categories could be aggregated into a brand group by selecting a specific combination of one or multiple brands and/or categories, wherein PMMs could be calculated for the brand group under consideration.

20. The method of claim 1 wherein the viewer-purchaser mappings could be implemented as crosswalk tables based on common keys (such as common IP addresses, email addresses, or hashed email addresses (HEMs) associated with purchaser identifiers and viewer identifiers) or through a third-party identity resolution services;
wherein unique viewer-purchaser identifiers for viewer-purchaser identity groups are created via direct concatenation of all viewer identifiers and purchaser identifiers of the group, or via application of various hashing techniques to a concatenation of all viewer identifiers and purchaser identifiers of the group, or via applying other standard methodologies.
